(19) United States
(12) Patent Application Publication
(10) Pub. No.: US 2025/0002649 A1
(43) Pub. Date: Jan. 2, 2025

(54) PROCESS FOR CONSECUTIVE BATCH PRODUCTION OF POLYAMIDE

(71) Applicant: INV Nylon Polymers Americas, LLC, Wilmington, DE (US)

(72) Inventors: Charles Richard Langrick, Cleveland (GB); Michael David Benstead, Stockton-on-Tees (GB)

(21) Appl. No.: 18/699,896

(22) PCT Filed: Oct. 20, 2022
(86) PCT No.: PCT/IB2022/060085

§ 371 Date: Apr. 10, 2024

(30) Foreign Application Priority Data
Oct. 22, 2021 (GB) 2115260.8

(51) Int. Cl. C08G 69/26; C08G 69/28

(52) U.S. Cl. CPC C08G 69/265; C08G 69/28

(57) ABSTRACT

A polymerisation process for consecutive batch production of a copolyamide comprising terephthalic acid, adipic acid and hexamethylenediamine, said process comprising the steps of: (a) introducing into a batch vessel said copolyamide monomeric units of terephthalic acid, adipic acid and hexamethylenediamine to provide a reaction mixture, (b) introducing into said batch vessel an end-capping agent and at least one comonomer(s) other than terephthalic acid, adipic acid and hexamethylenediamine; (c) subjecting the batch vessel contents to conditions sufficient to form said copolyamide; and (d) recovering said copolyamide product from the vessel, wherein the batch vessel is not cleaned out between batches.

### CROSS REFERENCE TO RELATED APPLICATIONS

This application claims priority to United Kingdom Application No. 2115260.8 filed on Oct. 22, 2021, which is incorporated by reference herein.

### FIELD

Disclosed is a process for making consecutive batches of semi-crystalline polyamides comprising terephthalic acid, adipic acid, and hexamethylenediamine and small amounts of at least one other comonomer (<6 mole % of each) and an end capping agent (0.5-2.5 mole %).

### BACKGROUND

Conventional hydrolytic polymerisation to produce polyamides, such as PA66, using batch autoclave technology and assets well known in the art is described by M I Kohan in Nylon Plastics Handbook (Section 2.3, pp. 17-20, ISBN 1-56990-189-9).

The hydrolytic polymerisation process is a two-phase process consisting of a liquid and a gas. The gas is mostly water vapour (steam) present as either bubbles within the liquid (hence two phases) or as a gas above the liquid. The liquid phase changes its nature during the polymerisation from that of dissolved monomers, through a mixture of dissolved monomers and oligomer, through to molten polymer at the end of the polymerisation process. The formation of solids or other inhomogeneities, such as gels, due to either solubility limits being exceeded, melting points not being achieved as species form, or degradation giving branched species, is detrimental and purposefully avoided by judicious temperature & pressure control during the polymerisation process. Failure to retain a homogeneous two-phase system may be described as “phase-out”.

The phase-out may manifest itself in various ways which may also depend upon the degree of phase-out: an inhomogeneous molten lace at casting with the formation of thick and thin sections (which may be describes as “blobs” and “thins”); a non-uniform viscous behaviour leading to surging at casting, that is on a short time scale there are rapid changes in viscosity: an entrapment of an excessive amount of bubbles: post casting analysis of the polymer's melting behaviour may find a population of high melting species, “high melts” or “un-melts”, beyond the expected melting point of the polymer: post casting analysis of the polymer's solidification behaviour may find it starts solidifying at higher temperatures than expected as commonly happens with polymers in which nucleants are present; or post casting analysis of the polymer may find that not all the polymer is soluble in a solvent, indicative of gel formation.

Whilst some small level of “un-melts” may be tolerable, too high a level will result in unacceptable pelletisation performance, and a poor yield due to the level of mis-shape pellets or even the need to “dump” the batch.

In contrast good casting performance may be characterised by a homogeneous molten lace: no surging which gives rise to blobs or thins: any viscosity changes are slow and gradual (it is well known in the art that polymers may exhibit a lower melt viscosity at the start of casting than the end due to continued polymerisation during the cast, but this is easily compensated for), and that the lace is substantially free of visible bubbles or at least any bubbles in the lace are small and at an acceptable level so as not to cause poor casting performance.

In commercial batch operations, when the molten contents of the polymerisation autoclave have reached the desired degree of polymerisation the contents are discharged from the vessel, which may be as strands of molten polymer which are then cooled, often in a water bath or sluice, and formed into pellets. However, the entire contents of the autoclave vessel are not easily discharged from it and a proportion of the contents remain adhered to the walls and other surfaces in the vessel. This minor amount of polymer on the inner surfaces of the reactor is often referred to as “the heel”. After the discharge the valve is closed.

It would be uneconomic to clean out this heel after each batch, and therefore it would be desirable to charge the next batch of monomer feed, usually a hot concentrated aqueous feed, into the autoclave with the heel present. The hot feed, however, is cooler than the solidification or melting point of the polymer which comprises the heel, and therefore the heel solidifies where it is. A consequence of this is that as this next batch is processed and polymerised the heel is being subjected to thermal treatment. Thermal treatment may induce annealing of the heel, perfecting any polymer crystallites formed and raising their melting point, a process well known in the art. This extra thermal treatment will also contribute to additional thermal degradants levels in the final polymer. At the interface between the heel and the hot feed, hydrolysis may occur to partially dissolve the surface of the heel into the hot liquid. The heel, therefore, only becomes fully incorporated back into this next batch when it has either become fully hydrolysed or the temperature of the system is sufficiently high that the heel is fluidised. However, there may still exist higher melting point species created during the annealing phase that persist until the system reaches a sufficiently high temperature to destroy them.

This mode of making batch-on-batch, or consecutive batches, therefore has its own challenges beyond a making a single batch on a clean autoclave and may produce polymers with subtly different properties to that off a clean autoclave. Various approaches have been proposed in the art for meeting the challenges of consecutive batch production of copolyamides while retaining the heel in the batch vessel between consecutive batches.

Conventionally, the art for naming repeat units of polyamides made from diamines and dicarboxylic acids is for the first character to represent (or label) the diamine and second character to represent (or label) the dicarboxylic acid. Polyamides which comprise repeat units of hexamethylene terephthalamide (6T or PA6T), derived from monomers, namely, hexamethylene diamine (6) and terephthalic acid (T) are commercially available.

These 6T-containing copolyamides are known to be particularly challenging to make and to avoid phase-out, but their ability to perform well in high temperature environments due to, for instance, their resistance to oxidation, high melting points, high glass transition temperatures, high heat distortion temperatures, or better flame retardant system properties, makes them attractive polymers for use in more extreme applications where polyamides, such as, PA6 or PA66 would struggle to meet the application demands.

The PAST homopolymer is itself intractable, melting at about 350-370° C. Hence, copolymers of it are made to lower the melting point to a level where melt processing is feasible, and the level of thermal degradation is tolerable. Comonomers to affect such a lowering of melting point may be based upon additional dicarboxylic acids, such as, adipic acid (6), or isophthalic acid (I); or additional diamines, such as 2-methylpentamethylenediamine (D); or amino-acids, such as 6-aminocaproic acid (6-ACA); or lactams, such as caprolactam, or combinations of these.

For commercial manufacturing of, and subsequent melt processing of by methods, such as but not limited to, compounding, injection molding, it is preferable to produce polymers with melting points between about 260° C. and 310° C. Lower than this there are few advantages over traditional PA66 (hexamethylene adipamide) polymer and above this temperature range degradation reactions, especially if aliphatic dicarboxylic acids comprise part of the polymer, become problematic.

It would be highly desirable to be able to produce such 6T-containing polymers on commercial assets that have been designed to make PA66 in order to avoid large investment cost. PA66 autoclaves are typically designed to operate at maximum working pressures of about 320 psia and with contents at about 330° C. to be well within safety margins, though they may typically be operated at about 265 psia and 290° C. when producing PA66.

It is also desirable to be able to utilise process variables commonly exercised in the art, such as time, temperature, pressure, depth of vacuum, to achieve final product properties such as solution viscosity. Similarly, to utilise normal formulation variables commonly exercised in the art, such as excess of diamine or dicarboxylic acid, to achieve final product properties, such as amine end group level (AEG). That there is interaction between process and formulation variables in achieving final product properties is well known in the art and means to account for, such as longer periods at high temperatures may result in higher hexamethylenediamine loss levels requiring additional hexamethylenediamine to be added to compensate for the loss.

Other additives, such as heat stabilisers, antioxidants, light and UV stabilisers, pigments, lubricants, nucleants, catalysts, acid scavengers and other additives known in the art, may optionally be added during any convenient stage of the polymerisation.

U.S. Pat. No. 3,941,755 (R. D. Chapman et al. Monsanto Co.) claims a fibre-forming PA6T/6I copolymer with between 60 and 80 m % (i.e. mole %) 6T, with boiling water shrinkage of between 10 and 30%. The problem of phase-out is described in paragraph Column 2 line 24, and means to prevent it, by either: the inclusion of a small, but effective, amount of heat stabiliser, using 6T and 6I salts having a pH of between 7.2±0.2 and if necessary conducting the polymerisation in the presence of a plasticizer; or using 6T and 6I salts having a pH of between 7.2±0.2 and carefully controlling the time taken to accomplish the second cycle of the polymerisation (when reaction mixture heated from about 220° C. at about 250 psig to 300° C. to 310° C. whilst maintaining constant pressure) to 35±5 minutes, and if necessary conducting the polymerisation in the presence of a plasticizer (paragraph Column 2 line 36).

U.S. Pat. No. 4,238,603 (R. D. Chapman et al, Monsanto Co.) describes the problem of making PA6T/6I with greater than 60 m % 6T in a batch autoclave making consecutive batches where the heel does not completely melt out in the next batch and results in particles in the polymer, a condition referred to as “polymer heterogeneity”.

U.S. Pat. No. 4,501,882 (L. W. Plischke, Monsanto Co.) claims a process for preparing successive (consecutive) batches of PA6T/6I copolymer with 45 to 80 m % 6T by adding a base, such as sodium hydroxide, in a sufficient amount to permit successive batches to be made without cleaning the vessel between successive batches.

U.S. Pat. No. 5,302,691 (R. R. Soelch, Du Pont Canada Inc.) describes the problem that arises when making PA6T/DT (D is 2-methylpentamethylenediamine (2-MPMD)) on the same autoclave without steps being taken to clean-out the autoclave between consecutive batches.

EP 655,076 (C. Leboeuf, Dupont Canada Inc.) describes a high-pressure process for the manufacture of PA6T/DT on a batch autoclave running consecutive batches (that is without clean out between batches).

U.S. Pat. No. 5,656,717 (C. Lebouef, Du Pont Canada Inc.) describes the same problem as EP 655,076.

Zytel® HTN 501 (Dupont) as disclosed in Thermochimica Acta 1998, 319, 201 (M Y Keating) is PA6T/DT 50/50 w % (same as m % in this instance, note the entire diacid is terephthalic acid), and Grivory® HT XE 3733 (EMS) is PA6T/6I 70/30 m % as disclosed in US2002/0173584 (M. Ebert et al, EMS) for would be members of the first subcategory, whilst Zytel®HTN502 (Dupont) is PA66/6T 45/55 m % as disclosed in US2011/0015328 (Y. Orihashi, Dupont), and Amodel® A1000 (Solvay) is PA66/6T/6I 10/65/25 (adipic acid/terephthalic acid/isophthalic acid mole % (m %) respectively) as disclosed in U.S. Pat. No. 5,436,294 (G. P. Desio et al, Amoco Corp.), would fall within the second category.

Aliphatic dicarboxylic acids, especially adipic acid, are more sensitive to thermal decomposition; hence, long periods of time at high melt temperatures will cause degradation of the aliphatic acid segments which is undesirable. Furthermore, the problem is exacerbated above that of PA66 polymerisation due to the higher melting points of PA66/6T and PA66/6T/6I polyphthalamides. The challenge for producers has been to devise processes to minimise the degradation whilst still achieving polymerisation and satisfactory polymer quality.

PA66/6T is a well-established copolyamide. Schlack (DE 929,151) reported on the hydrolytic melt polymerisation preparation of PA66/6T copolymer and melting points for compositions up to 50 mole % 6T (50 m % 6T). No consideration of making consecutive batches of the polymers was given.

Unlike most copolymer systems which suffer a drop in melting point to a minimum at some composition between the melting points of the pure homopolymers, PA66/6T exhibits isomorphism of the 6T repeat unit into the PA66 crystal lattice, the isomorphous nature means that in PA66/6T there tends to be a gradual rise in melting point between the melting points of the PA66 and PA6T homopolymers at levels above 20 m % 6T or there abouts, as reported by A. J. Yu and R. D. Evens J.Polymn.Sci, 1960, XLII, 249-257.

GB1,114,541 (O. B. Edgar) claims ternary copolyamides comprising of a major proportion of PA66, at least 20 w % PA6T and minor proportion of a third copolyamide, such as PA6I, preferably 20-40 w % PA6T and 5-10 w % of the third copolymer. Example 1 is a PA66/6T/6I 58/31.5/10.5 w % (60/30/10 m %) copolymer made using 1 mole acetic acid and analysed for 44 moles per million grammes polymer acetyl ends. Example 2 is a PA66/6T/6I 72.8/21.9/5.3 (74.7/20.6/4.7 m %) copolymer made using 0.55 mol acetic acid.

U.S. RE34447 (reissue of U.S. Pat. No. 4,603,166, W. Poppe et al, Amoco Corp.) describes processes for producing PA6T/6I/66 copolymers with 65-90/25-0/35-5 m % ranges (with 6I/66 mole ratio is less than 3:1) respectively, wherein a first process a low molecular weight prepolymer is made which in subsequent processes is transformed into high molecular weight polymer. One process as exemplified consists of rapidly making a very low molecular weight prepolymer (a polyamide oligomer) by heating an aqueous solution of the monomers together at high temperatures (328° C.) and pressures (1800 psig) for short periods of time (40 seconds) before being fed to a flash reactor where the reaction mixture may reach up to 333° C. whilst pressure is reduced to about 0-400 psig with a residence time of about 10 seconds (the flash reactor may be operated in batch, batch-continuous or continuous mode) then finishing the polycondensation in, for example, a twin screw reactor/extruder configured to raise the molecular weight. In another process a low molecular weight prepolymer is exemplified as being made in a batch reactor at about 315° C. and 130 psig pressure and isolated as a granulate which is subsequently fed to a twin-screw reactor/extruder configured to raise the molecular weight. Such multi-step processes are more complex than a conventional single-step autoclave process.

JPS61,159,422 (K. Koichi et al, Toray Ind Inc.) describes a process for producing PA66/6T polymers which contain 20-60 w % 6T (about 19-38 m %) by limiting the maximum melt temperature to between 5 to 15° C. above the melting point of the obtained copolymer. In order to control the molecular weight of the polymer, 0.7-4.0 m % viscosity stabiliser, such as acetic acid, based on salts is added.

JPH04,337,323 (S. Kataoka et al. Toray Ind Inc.) relates to a method for producing a polyamide resin for blow molding which has good heat resistance, chemical resistance, low water absorption, antifreezing resistance, dimensional stability and improved melt retention stability.

EP 3,502.165 (Rhodia Operations) describes the problem of encrustation of used autoclaves when preparing PA66/6T copolyamides and which must be removed periodically by extensive cleaning. The patent claims a process for producing a copolyamide comprising less than 50 mole % 6T units by polymerising a concentrated mixture of the salts in an autoclave at a pressure of at least 1.2 MPa by increasing the temperature up to a temperature higher than the final melting point of the copolyamide prior to releasing the pressure, allowing further polymerisation to continue, prior to granulating the product.

U.S. Pat. No. 10,875,962 (M. D. Benstead, INVISTA North America S.A.R.L.) describes methods of making polyamide copolymer including PA66/6T comprising 10-39 m % 6T and making such polymers in a consecutive batch mode (that is on the heel of the previous batch). Acetic acid is optionally added in amounts of 0.1 to 10 m % as an end-capping agent to limit molecular weight to improve casting performance.

It is an object of the invention to address one or more of the afore-mentioned problems. In particular, it is an object of the invention to provide an improved process for producing consecutive batches of semi-crystalline polyamides comprising terephthalic acid, adipic acid, and hexamethylenediamine, particularly at relatively high mole fractions of 6T. It is a particular object of the present invention to address the problem of heel retention while retaining good product quality. Advantageously, the process should be operable on existing commercial assets, for instance those suitable for manufacturing PA66.

### SUMMARY

The inventors have surprisingly found that by judicious incorporation of from 0.5 to 2.5 m % end capping agent, and incorporation of small amounts of from 0.5 to 6.0 m % of at least one other comonomer (also referred to herein as a disruptor), it is possible to practice a polymerisation process for producing consecutive autoclave batches of semi-crystalline polyamides comprising terephthalic acid, adipic acid, and hexamethylenediamine where the m % 6T is from 25 to 45 m % and at maximum pressure of about 320 psia and where the maximum contents temperature during the highest pressure stage that is less than the melting point of the final polymer and limiting the final contents temperature to a maximum of about 320° C.

Without limiting the scope of the present invention by theory, it is the inventors' contention that the problems which have been described herein on the production of copolymers comprising 6T are the result of the formation of blocks of 6T repeat units, also meant to be understood as 6T-rich blocks in isomorphous systems, along the copolyamide chain. There will exist a distribution in the lengths of such block, determined by the statistics and kinetics of the system. In systems with a high m % level of 6T there is a greater statistical chance of forming a large proportion of longer block lengths as compared to systems with a lower m % 6T. In systems where there exist significant differences between the reactivity of the terephthalic acid and other carboxylic acids undergoing polymerisation, such as adipic acid which being aliphatic is more reactive, this may lead to kinetic compositional drift as the chain grows. In PA66/6T, for instance, PA66-rich polymer may form first and PA6T-rich segments form later. The 6T is thus concentrated beyond the initial composition and likely to form longer 6T repeat unit blocks than if reactivity had been equal.

In semi-crystalline polymers, the thicker the lamellae in a crystallite the higher its melting point is (Thomson-Gibb equation as in B. Wunderlich & G. Czornyj; Macromolecules, 1977, 19 (5), 906-913). The longer the 6T repeat unit blocks are the more able they are to form larger crystals and so exhibit higher melting points. Thus, when such blocks are formed during the melt polymerisation process they may aggregate together and if the temperature of the mass is not sufficiently high for the length of 6T repeat unit block formed then they may crystallise, that is phase-out. The amount of phase-out may vary from a very small fraction of the rest of the fluid mass of molten polymer, to the whole system freezing.

As noted earlier, when producing polymer in a batch-on-batch (or consecutive batch) mode without cleanout between the batches, there exists a residual heel of polymer from a previous batch that is being heated and annealed during the subsequent polymerisation. During this annealing process crystals of 6T repeat units may grow due to thermal motion being sufficient to allow rearrangement. Consequently, their melting points will increase, and manifest as problems of producing satisfactory polymer which are not observed when making a single batch of polymer on a clean autoclave.

The other comonomers (or disruptors), i.e. those which are not terephthalic acid, adipic acid or hexamethylenediamine, suitable for use in the invention may be organic diamines such as (and without limitation to): pentamethylenediamine; 2-methylpentamethylenediamine; octanediamine; m-xylylenediamine; 2-methyloctanediamine; bis(p-aminocyclohexyl)methane; nonanediamine; decanediamine; 2,4,4-trimethylhexamethylenediamine: 2,2,4-trimethylhexamethylenediamine; and isophoranediamine, and/or organic dicarboxylic acids such as (and without limitation to); azelaic acid; isophthalic acid; sebacic acid; dodecanedioic acid; and 2,6-naphthanene dicarboxylic acid, and/or organic aminocarboxylic acids such as (and without limitation to); 6-aminohexanoic acid; 7-aminoheptanoic acid; 11-aminoundecanoic acid; and 12-aminododecanoic acid, and/or organic lactams such as (and without limitation to); caprolactam; and laurolactam. The preferred other comonomer(s) used in the present invention is/are selected from isophthalic acid (I), 2-methylpentamethylenediamine (D) and combinations thereof.

Typically no more than two of said comonomers are present in the copolyamide.

Where a plurality of comonomers are present in the copolyamide, the total amount of comonomers is preferably no more than 12 m %, preferably no more than 10 m %.

It will be appreciated that said comonomer(s) are incorporated into the backbone of the polymer chains of the copolyamide product.

Without limiting the scope of the invention by theory, such comonomers are thought to insert within the 6T repeat unit blocks, reducing their length and hence the ability to make thicker lamellae and thus form high melting crystallites upon crystallisation. Such comonomers may, therefore, be thought of, and referred to herein, as disruptors. If too much comonomer is used, then the melting point of the polymer may be so reduced, or the degree of crystallinity of the polymer so reduced, that other desirable properties, such as good tensile strength or impact strength, become unachievable.

In a similar manner, end capping agents may limit the length that a 6T block can form and hence curtail the ability to make thicker lamellae and thus form high melting crystallites upon crystallisation. If too much end capping agent is present, then the molecular weight of the polymer may be so reduced that other desirable properties, such as good tensile strength or Impact strength, become unachievable.

The inventors have found that the inclusion of an end-capper and other comonomer in the afore-mentioned ranges reduces or minimises heel accumulation during production of the polymer, while at the same time providing a high-performance end-product, particularly wherein mechanical properties (such as tensile strength and/or impact strength) are maintained or improved, and/or without significant reduction of the melting point of the polymer. The invention is particularly advantageous semi-crystalline polyamides comprising terephthalic acid, adipic acid, and hexamethylenediamine where the m % 6T is from 30 to 45 m %, particularly from 35 to 45 m %, particularly from 40 to 45 m %.

The process of the present invention advantageously minimises or avoids between-batch cleaning, and hence sustainably reduces the use of additional solvent and disposal of spent solvent used in such cleaning. Furthermore, the present invention improves the sustainability, efficiency and economy of the manufacturing process by improving productivity, and minimising off-target or defective product.

The process of the present invention allows consecutive batch production of the copolyamide while either at least maintaining the relative viscosity of the product in consecutive batches, or without a significant drop therein. As used herein, a significant drop in relative viscosity is defined as a drop of more than 0.5 in the relative viscosity (RVS, as defined hereinbelow) in consecutive batches, or over a cycle of up to 4 consecutive batches. Preferably, the process of the present invention exhibits a drop in relative viscosity (RVS) in consecutive batches (and preferably over a cycle of up to 4 consecutive batches) of no more than 0.5, preferably no more than 0.4, preferably no more than 0.3, preferably no more than 0.2, preferably no more than 0.1.

Any suitable end-capping agent known or conventional in the art may be used, including mono-functional organic carboxylic acids such as acetic acid, benzoic acid, propionic acid, stearic acid and the like, and mono-functional organic amines and particularly alkyl amines such as n-hexylamine and the like. 1,4-Dicarboxylic acids such as succinic acid are also known end-capping agents because these can react with an amine end to form an end-capping 5-membered imide ring structure. Other end-capping agents include anhydrides, such as phthalic anhydride which can form end-capping 5-membered imide ring structures, and 1,8-naphthalene anhydride which can form end-capping 6-membered imide ring structures. Of particular utility are mono-functional organic acids (i.e. having one dicarboxylic acid group) and mono-functional organic amines (i.e. having one amine group). A preferred end capping agent is acetic acid (AcOH). One or more end-capping agents may be used, but typically only one end-capping agent is used.

2-Methylpentamethylenediamine (D) is commercially available under the tradename INVISTA Dytek® A amine. It is commercially produced by hydrogenating 2-methylglutaronitrile (or “MGN”). MGN is a branched C₆ dinitrile obtained as a side-product from butadiene double-hydrocyanation process of adiponitrile [or ‘ADN”] manufacture. The otherwise disposed MGN side-product can be recycled and reused in the production of INVISTA Dytek® A amine. Thus, the use of 2-methylpentamethylenediamine in the present invention sustainably and advantageously recycles amine content.

The copolyamides produced by the process of the present invention are preferably no block copolymers, but instead are preferably random or essentially random copolymers.

### DETAILED DESCRIPTION OF THE PREFERRED EMBODIMENTS

According to the present invention, semi-crystalline polyamides comprising terephthalic acid, adipic acid, and hexamethylenediamine where the m % 6T is in the range of from 25 to 45 m % and incorporation of small amounts in the range of from 0.5 to 6.0 m % of at least one other comonomer and from 0.5 to 2.5 m % end capping agent may be produced in a batch autoclave in a consecutive batch mode (batch-on-batch) without cleaning out the autoclave between batches.

Reactants for the polymerisation may be introduced into the autoclave in any convenient form and at any convenient temperature and pressure. In one embodiment a concentrated (≤25 w % water) aqueous salt solution comprising of terephthalic acid, adipic acid, hexamethylenediamine, end-capping agent and at least one other comonomer is supplied at convenient temperature, pressure and concentration from an evaporator vessel in a similar manner to that which is well practiced in the art for PA66. In another embodiment a moderately concentrated (≥40 w % water) aqueous salt solution comprising of terephthalic acid, adipic acid, hexamethylenediamine, end-capping agent and at least one other comonomer is supplied at convenient temperature, pressure, and concentration to the autoclave.

The polymerisation of a batch may be conveniently described as being conducted in six cycles.

In the first cycle the aqueous salt solution comprising monomers and reactants described above is introduced into an autoclave vessel prepared and awaiting introduction of the salt solution. Optionally other additives, such as antifoam agents, catalysts may be added at this stage. If the salt solution is moderately dilute the contents may be heated and venting allowed in order to evaporate off water; pressure may be controlled at a setpoint between about 30 psia to 250 psia, venting is ceased when the temperature reaches a setpoint between about 160° C. to 200° C. If the salt solution is sufficiently concentrated then when all the hot solution (which is between about 160° C. to 200° C.) is added, the second cycle commences.

In the second cycle, heating is continued to raise the pressure and temperature. The second cycle ceases when the pressure reaches a setpoint between about 250 psia and 320 psia, which is the maximum pressure of the process.

In the third cycle, venting commences whilst the temperature rises to a setpoint between about 245° C. and 290° C. and which is less than the melting point of the final polymer.

In the fourth cycle, the pressure is reduced from the maximum pressure to atmospheric pressure, the pressure reduction may be made in stages with intermediate hold pressures and setpoint temperature targets, which may be above the melting point of the final polymer, or may be a single steady pressure reduction. The fourth cycle may take from about 15 minutes to 120 minutes, preferably from about 25 to 40 minutes, and more preferably from 30 to 35 minutes.

During the fifth cycle when the pressure has reached atmospheric pressure the system may be allowed to freely vent allowing vapours comprising water to evaporate away, the molten contents are brought to their final temperature and held for any desired length of time which gives a final polyamide of the desired properties. Optionally vacuum may be applied during this cycle at any depth of vacuum for any length of time which gives a final polyamide of the desired properties.

In the sixth cycle, a small pressure is applied, typically by application of nitrogen gas, to the autoclave and polymer is extruded via a casting valve and formed into pellets by means well known in the art.

The cast is complete when the casting valve begins to blow through nitrogen gas, and the casting valve is closed. Note there remains polymer residue, the heel, in the autoclave which was not cast.

The autoclave is now back at cycle one of the next batch and is prepared to await the introduction of the aqueous salt solution. The optimum time, temperature, pressure, depth of vacuum involved in conducting each of the cycles will vary somewhat depending upon the polymer composition.

The invention is particularly defined by the following numbered statements:

1. A polymerisation process for producing consecutive batches of a copolyamide comprising terephthalic acid, adipic acid and hexamethylenediamine, said process comprising the steps of:
a. introducing into a batch vessel said copolyamide monomeric units of terephthalic acid, adipic acid and hexamethylenediamine to provide a reaction mixture,
b. introducing into said batch vessel an end-capping agent and at least one comonomer(s) other than terephthalic acid, adipic acid and hexamethylenediamine;
c. subjecting the batch vessel contents to conditions sufficient to form said copolyamide; and
d. recovering said copolyamide product from the vessel, wherein the batch vessel is not cleaned out between batches.
   2. A process according to statement 1, wherein the process comprises the production of a first batch of said copolyamide and the recovery thereof from said batch vessel in accordance with said steps (a) to (d), and further comprises the production of a second batch of said copolyamide and optionally at least one subsequent batch of said copolyamide, wherein the production steps of each of said second and optional subsequent batch(es) correspond to said steps (a) to (d).
   3. A process according to statement 1 or 2 wherein upon completion of step (d) in each production batch there remains in the batch vessel residual copolyamide product, defined as the heel, and wherein said second and optional subsequent batch(es) are processed on the heel of the preceding batch, preferably wherein the amount of said heel represents no more than 10 weight % of the maximum theoretical yield from the batch.
   4. A process according to any of the preceding statements wherein said reaction mixture further comprises a solvent, preferably water.
   5. A process according to any of the preceding statements wherein said terephthalic acid, adipic acid, hexamethylenediamine, end-capping agent and other comonomer(s) are contacted in a mixing vessel and then introduced, preferably in the form of a feed solution, into said batch vessel.
   6. A process according to any of the preceding statements wherein said adipic acid and a portion of the total amount of said hexamethylenediamine needed to make the copolyamide are in the form of a nylon salt, preferably wherein said portion is an approximately stoichiometric amount of said hexamethylenediamine relative to the amount of adipic acid. As used herein, the term “approximately stoichiometric amount” means an HMD: AA ratio of no more than 10% either side of 1.00:1.00, i.e. in the range of 1.10:1.00 to 1.00:1.10. Preferably, a stoichiometric salt is used, in order to maximise the molecular weight attainable by the process.
   7. A process according to statement 6 wherein said terephthalic acid, said salt and said other comonomer(s) are contacted in a mixing vessel and additional hexamethylenediamine added thereto, wherein said end-capping agent may be contacted with said terephthalic acid, said salt and said other comonomer(s) or may be added to the mixture comprising said terephthalic acid, said salt and said other comonomer(s) simultaneously with or in the same composition as said additional hexamethylenediamine.
   8. A process according to any of the preceding statements wherein the total amount of diamine in the reaction mixture, and preferably the total amount of hexamethylenediamine in the reaction mixture, is in excess relative to the combined molar amount of adipic acid, terephthalic acid and any carboxylic acid-containing compounds of said other comonomer(s), preferably wherein said excess is from 0.1 to 5.0 m % relative to the combined molar amount of adipic acid, terephthalic acid and any carboxylic acid-containing compounds of said other comonomer(s).
   9. A process according to any of the preceding statements wherein the batch vessel is subjected to a maximum pressure of about 320 psia, wherein the maximum temperature of the vessel contents during the highest pressure stage is less than the melting point of the final copolyamide product.
   10. A process according to any of the preceding statements wherein the temperature of the final contents of the batch vessel is limited to a maximum of 320° C.
   11. A process according to any of the preceding statements wherein the batch vessel is an autoclave.
   12. A process according to any of the preceding statements wherein the copolyamide product comprises from 0.5 to 2.5 m % end-capping agent, preferably from 1.0 to 2.0 m %.
   13. A process according to any of the preceding statements wherein the copolyamide product comprises from 0.5 to 6.0 m %, preferably from 2.0 to 6.0 m %, preferably from 2.0 to 5.5 m %, preferably from 2.0 to 5.0 m %, preferably from 2.0 to 4.5 m %, of each of said one or more comonomer(s) other than terephthalic acid, adipic acid, or hexamethylenediamine.
   14. A process according to any of statements 1 to 12 wherein the copolyamide product comprises no more than 4.5 m %, preferably from 0.5 to 4.5 m %, preferably from 2.0 to 4.5 m %, of each of said one or more comonomer(s) other than terephthalic acid, adipic acid, or hexamethylenediamine.
   15. A process according to any of the preceding statements wherein the copolyamide product comprises a plurality of said comonomer other than terephthalic acid, adipic acid, or hexamethylenediamine, and the total amount of said comonomers is no more than 12 m %, preferably no more than 10 m %.
   16. A process according to any of the preceding statements wherein the copolyamide product exhibits a hexamethylene terephthalamide mole fraction, which is defined as the 6T component, of from 25 to 45 m %.
   17. A process according to any of the preceding statements wherein the copolyamide product exhibits a hexamethylene adipamide mole fraction, which is defined as the 66 component, of from 50 to 70 m %.
   18. A process according to any of the preceding statements wherein where the copolyamide product exhibits a hexamethylene terephthalamide mole fraction (6T component) of from 35 to 45 m %, and particularly from 40 to 45 m %, then the amount of at least one, and preferably each, of said one or more comonomer(s) other than terephthalic acid, adipic acid, or hexamethylenediamine present in the copolyamide is in the range of 2.5 to 6.0 m %, preferably 3.0 to 6.0 m %, preferably 3.5 to 6.0 m %, and preferably 4.0 to 6.0 m %.
   19. A process according to any of the preceding statements wherein where the copolyamide product exhibits a hexamethylene terephthalamide mole fraction (6T component) of from 35 to 45 m %, and particularly from 40 to 45 m %, then the total amount of hexamethylenediamine in the reaction mixture is in excess relative to the combined molar amount of adipic acid, terephthalic acid and any carboxylic acid-containing compounds of said other comonomer(s) wherein said excess is from 3.0 to 5.0 m % relative to the combined molar amount of adipic acid, terephthalic acid and any carboxylic acid-containing compounds of said other comonomer(s).
   20. A process according to any of statements 1 to 17 wherein the copolyamide product exhibits a hexamethylene terephthalamide mole fraction (6T component) of less than 35 m % and the total amount of hexamethylenediamine in the reaction mixture is in excess relative to the combined molar amount of adipic acid, terephthalic acid and any carboxylic acid-containing compounds of said other comonomer(s) wherein said excess is from 0.1 to less than 3.0 m % preferably 0.1 to 1.0 m % relative to the combined molar amount of adipic acid, terephthalic acid and any carboxylic acid-containing compounds of said other comonomer(s).
   21. A process according to any of the preceding statements wherein the end-capping agent is selected from: mono-functional organic carboxylic acids such as acetic acid, benzoic acid, propionic acid, stearic acid; mono-functional organic amines and preferably alkyl amines such as n-hexylamine; 1,4-dicarboxylic acids such as succinic acid which react with an amine end to form an end-capping 5-membered imide ring structure; anhydrides such as phthalic anhydride which react with an amine end to form an end-capping 5-membered imide ring structure; and anhydrides such as 1,8-naphthalene anhydride which react with an amine end to form an end-capping 6-membered imide ring structure, and preferably wherein the end-capping agent is acetic acid.

22. A process according to any of the preceding statements wherein said at least one comonomer(s) other than terephthalic acid, adipic acid and hexamethylenediamine are selected from organic diamines, organic dicarboxylic acids, organic aminocarboxylic acids and organic lactams, preferably wherein said organic diamines are selected from pentamethylenediamine, 2-methylpentamethylenediamine, octanediamine, m-xylylenediamine, 2-methyloctanediamine, bis(p-aminocyclohexyl)methane, nonanediamine, decanediamine, 2,4,4-trimethylhexamethylenediamine, 2,2,4-trimethylhexamethylenediamine and isophoranediamine; and/or preferably wherein said organic dicarboxylic acids are selected from azelaic acid, isophthalic acid, sebacic acid, dodecanedioic acid and 2,6-naphthanene dicarboxylic acid; and/or preferably wherein said organic aminocarboxylic acids are selected from 6-aminohexanoic acid, 7-aminoheptanoic acid, 11-aminoundecanoic acid and 12-aminododecanoic acid; and/or preferably wherein said organic lactams are selected from caprolactam and laurolactam.

23. A process according to any of the preceding statements wherein said at least one comonomer(s) other than terephthalic acid, adipic acid and hexamethylenediamine are selected from isophthalic acid (I), 2-methylpentamethylenediamine (D) and combinations thereof.
24. A process according to any preceding statement wherein said at least one comonomer other than terephthalic acid, adipic acid and hexamethylenediamine is isophthalic acid (I), preferably wherein the copolyamide product comprises no more than 4.5 m %, preferably from 0.5 to 4.5 m %, preferably from 2.0 to 4.5 m %, of said isophthalic acid (I), optionally wherein said isophthalic acid (I) is in combination with 2-methylpentamethylenediamine (D).
25. A process according to any preceding statement wherein said at least one comonomer other than terephthalic acid, adipic acid and hexamethylenediamine is 2-methylpentamethylenediamine (D), preferably wherein the copolyamide product comprises from 0.5 to 6.0 m %, preferably from 2.0 to 6.0 m %, preferably from 2.0 to 5.5 m %, preferably from 2.0 to 5.0 m %, preferably from 2.0 to 4.5 m %, of said 2-methylpentamethylenediamine (D), optionally wherein said 2-methylpentamethylenediamine (D) is in combination with isophthalic acid (I).
26. A process according to any of the preceding statements wherein said copolyamide product is a semi-crystalline copolyamide.
27. A process according to any of the preceding statements wherein said copolyamide product which exhibits a Relative Viscosity measured in a 1.0 wt./vol. % solution of the copolyamide sample in 96% sulfuric acid according to ASTM D789 Method is in the range of 1.8 to 2.8, and an amine end group content in the range of 15 to 100 mpmg.
28. A process according to any of the preceding statements wherein said copolyamide product exhibits a crystallization temperature of greater than 220.0° C., preferably at least 222.0° C., preferably greater than 225.0° C., preferably at least 227.0° C., preferably at least 230.0° C., and preferably no more than 260.0° C., preferably no more than 255.0° C., preferably no more than 250.0° C.; and preferably the crystallization temperature of the copolyamide product is in the range of from greater than 220.0° C. to no more than 260.0° C., preferably in the range of from at least 222.0° C. to no more than 260.0° C., preferably in the range of from greater than 225.0° C. to no more than 260.0° C., preferably in the range of at least 227.0° C. to no more than 260.0° C., preferably at least 230.0° C., and preferably no more than 255.0° C., and preferably no more than 250.0° C.
29. A process according to any of the preceding statements wherein said copolyamide product exhibits a melting point of no more than 320.0° C., preferably at least 250.0° C.: preferably the melting point of the copolyamide product is in the range of from 250.0 to 320.0° C.
30. A copolyamide made according to the process of any of statements 1 to 29.
31. A copolyamide containing monomeric units derived from terephthalic acid, adipic acid, hexamethylenediamine, at least one comonomer other than terephthalic acid, adipic acid and hexamethylenediamine, and an end-capping agent, wherein the Relative Viscosity measured in a 1.0 wt./vol. % solution of the copolyamide sample in 96% sulfuric acid according to ASTM D789 Method is in the range of 1.8 to 2.8, and wherein the amine end group content is in the range of 15 to 160 mpmg, preferably.
32. A copolyamide according to statement 31 wherein the copolyamide is as defined in any of statements 12 to 30.

### Measurements and Tests

Molecular weight of polyamide resins is typically inferred by the measurement of solution viscosity. The two most common methods are: (i) ASTM D789 for relative viscosity (RV) measurement, and (ii) ISO 307 using sulfuric acid to obtain viscosity number (VN) values. Viscosity values and trends to be considered are determined by the same method, regardless of which method is selected.

The term “RV” or “RVF”, used herein in the Examples, refers to relative viscosity of a polymer sample as measured (unless otherwise indicated) in an 8.4 wt % solution in 90% formic acid, in accordance with ASTM D789.

The term “RVS” refers to the relative viscosity as measured in a 1.0 w/v % solution of the polymer sample in 96% sulfuric acid, in accordance with ASTM D789.

The term “VNF” refers to the viscosity number obtained from a 0.5 w/v % solution of the polymer sample in 90% formic acid, in accordance with ISO 307.

The term “VNS” refers to the viscosity number obtained from a 0.5 w/v % solution of the polymer sample in 96% sulfuric acid, in accordance with ISO 307.

Polymer amine ends can be measured by direct titration with standardized perchloric acid solution of weighed polymer samples taken up in solution. In a preferred method, about 1.5000 g of accurately weighed dried polyamide is dissolved in 50 mL of a 68 w/v % phenol solution in methanol at about 75° C. The cooled solution (about 25° C.) is titrated with a standardized solution of 0.05 M perchloric acid in 1-propanol using an autotitrator (Metrohm 905 Titranado, Tiamo Software and accessories). Amine end group (AEG) concentration results are reported in moles per million grams polymer (mpmg), equivalent to mmol per Kg.

Other suitable solvents include 80 w % phenol in methanol, or m-cresol. A few drops of an indicator, such as a 0.1 w % methyl orange and 0.1 w % xylene cyanol mix in water may be added to aid visual confirmation of end point detection.

Melting and crystallization transitions were determined by Differential Scanning Calorimetry on a Perkin Elmer DSC 8500 under a nitrogen atmosphere. 5-20 mg of accurately weighed polymer was used. The following heating method was used:
(i) Initial heating was conducted from 30° C. to 300° C. (or higher to get at least 10° C. beyond end of melting processes) at 10° C. per minute,
(ii) held for 1 minute at the final temperature from step (i) then cooled at 50° C. per minute back to 30° C.,
(iii) reheated to 300° C. (or higher to get at least 10° C. beyond end of melting processes) at 10° C. per minute,
(iv) held for 1 minute at the final temperature from step (iii) then cooled at 50° C. per minute back to 30° C.

The enthalpies of melting (ΔHm) were determined for each heating stage. From the first cooling stage, the onset of crystallization temperature (Tc1,o) was determined, and this is referred to herein as the “crystallisation temperature” of the polymer, unless otherwise indicated. From the re-heat stage, the end of melting process temperature (Tm2,e) was determined, and this is referred to herein as the “melting temperature” (or “melting point”) of the polymer, unless otherwise indicated.

### EXAMPLES

### Example 1 (E1.1) PA66/6T/6I 58/40/2 m %

A 40 m % 6T formulation with isophthalic acid as a comonomer other than hexamethylenediamine, adipic acid and terephthalic acid. Acetic acid [AcOH] used as an end-capping agent.

Into a 20 L temperature controlled jacketed glass vessel fitted with overhead stirrer and condenser and maintained under an atmosphere of nitrogen was added 6361 g demineralised water, 4110 g (15.67 mol) nylon 66 salt, 1794 g (10.8 mol) terephthalic acid, 89.7 g (0.54 mol) isophthalic acid and 24.3 g (0.4 mol) acetic acid. 2375 g of a 56 w % aqueous solution of hexamethylenediamine (1330 g, 11.44 mol) was added via peristaltic pump whilst maintaining a temperature of 80° C. This produced a solution about 49 w % in strength with a mole ratio of 66/6T/6I of about 58/40/2 and contained a 1.5 m % addition of acetic acid on combined moles of adipic acid, terephthalic acid and isophthalic acid, and a 0.4 m % excess of hexamethylenediamine on combined moles of adipic acid, terephthalic acid and isophthalic acid.

This solution was added to a clean 24 L oil-heated autoclave with an agitator, together with 4.6 g sodium hypophosphite hydrate (0.43 mol, equivalent to 212 ppm P in final polymer) and 0.59 g of a 50 w % aqueous solution of Silwet L7605 antifoam agent (47 ppm active ingredient based on final polymer).

In this first cycle the solution was heated and vented when the pressure reached 170 psia and continued until the temperature had reached 198° C. In the second cycle venting was ceased and the pressure allowed to rise to 265 psia over 14 minutes by when the temperature of the contents had increased to about 217° C. In the third cycle venting was continued for 48 minutes whilst keeping the system at 265 psia until the temperature of the contents had reached 254° C. In the fourth cycle the pressure was reduced to atmospheric pressure over 35 minutes and the temperature of the contents had been increased to 290° C. In the fifth cycle vacuum was applied and the pressure reduced to 500 mbar over 11 minutes and held at 500 mbar for 4 minutes, the vacuum was released with nitrogen over 1 minute and the temperature had reached 294° C. In the sixth cycle the polymer was extruded from the autoclave by a bottom extrusion valve using a maximum nitrogen pressure of 80 psia. When nitrogen blow-through occurred, the pressure was released, and the extrusion valve sealed. The vessel contained residual polymer, the heel, and was ready for the next batch for processing.

A second batch (E1.2), processed on the heel of the first, was processed in essentially the same manner as the first. The polymer cast well without problems of thick/thin lace, was of good and consistent viscosity with no visible signs of un-melted material and pelletization was possible.

A further four batches (E1.3, E1.4, E1.5, E1.6) were continued to be processed in this consecutive batch mode. The last batch (fifth batch as a batch-on-heel batch) cast as well as the second batch (first batch on a heel) had cast.

### Comparative Example 1A (CE1A.1) PA66/6T 60/40 m % [No “I” or “D” Comonomer]

A 40 m % 6T formulation with no comonomers other than hexamethylenediamine, adipic acid and terephthalic acid. Acetic acid used as an end-capping agent.

Into a 20 L temperature controlled jacketed glass vessel fitted with overhead stirrer and condenser and maintained under an atmosphere of nitrogen was added 6467 g demineralised water, 4250 g (16.2 mol) nylon 66 salt, 1794 g (10.8 mol) terephthalic acid, and 24.3 g (0.4 mol) acetic acid. 2113 g of a 60 w % aqueous solution of hexamethylenediamine (1268 g, 10.91 mol) was added via peristaltic pump whilst maintaining a temperature of 80° C. This produced a solution about 49 w % in strength with a mole ratio of 66/6T of about 60/40 and contained a 1.5 m % addition of acetic acid on combined moles of adipic acid and terephthalic acid, and a 0.4 m % excess of hexamethylenediamine on combined moles of adipic acid and terephthalic acid.

This solution was added to the 24 L autoclave used in Example 1 together with 4.55 g (0.04 mol) sodium hypophosphite hydrate (to give 210 ppm P in final polymer) and 0.57 g Silwet L7605 (50%, to give 45 ppm active antifoam based upon final polymer).

In this first cycle the solution was heated and vented when the pressure reached 170 psia and continued until the temperature had reached 198° C. In the second cycle venting was ceased and the pressure allowed to rise to 265 psia over 15 minutes by when the temperature of the contents had increased to about 218° C. In the third cycle venting was continued for 54 minutes whilst keeping the system at 265 psia until the temperature of the contents had reached 255° C. In the fourth cycle the pressure was reduced to atmospheric pressure over 35 minutes and the temperature of the contents had been increased to 297° C. In the fifth cycle vacuum was applied and the pressure reduced to 500 mbar over 11 minutes and held at 500 mbar for 4 minutes, the vacuum was released with nitrogen over 1 minute and the temperature had reached 299° C. In the sixth cycle upon casting there was a small plug of material initially which was cleared and then a good cast was made without problems of thick/thin lace, the extruding polymer was of good and consistent viscosity with no visible signs of unmelted material. When nitrogen blow-through occurred, the pressure was released, and the extrusion valve sealed. The vessel contained residual polymer, the heel, and was ready for the next batch for processing.

A second batch (CE1A.2) was processed on the heel of the first and was processed in essentially the same manner as the first. A poor cast ensued which manifest as thick and thin lace forming due to apparent viscosity variations upon extrusion of the lace from the autoclave, the thick sections described as “gel-like”. It was not possible to form a sufficiently consistent lace to pelletise the material and the remains of the polymer contents in the autoclave were cast into a metal bucket.

This comparative example shows that it was not possible to perform consecutive batches and achieve good casting performance, as compared to Example 1 which had the benefit of incorporation of a small amount of another comonomer in addition to the hexamethylenediamine, adipic acid and terephthalic acid.

### Comparative Example 1B (CE1B.1) PA66/6T 60/40 m % [No “I” or “D” Comonomer]

A 40 m % 6T formulation with no comonomers other than hexamethylenediamine, adipic acid and terephthalic acid. Acetic acid used as an end-capping agent.

Into a 20 L temperature controlled jacketed glass vessel fitted with overhead stirrer and condenser and maintained under an atmosphere of nitrogen was added 4464 g demineralised water, 1622 g (11.08 mol) adipic acid, 1228 g (7.39 mol) terephthalic acid, 2650 g of an 80 w % aqueous solution of hexamethylenediamine (HMD) was added via peristaltic pump whilst maintaining a temperature of 80° C. (2120 g, 18.24 mol) the pH was adjusted to 7.50 (diluted to 9.5 w % solution, 25° C.) by the addition of a further 58 g 80% HMD solution (total HMD 2178 g, 18.64 mol). This produced a solution about 50 w % in strength with a mole ratio of 66/6T of about 60/40.

This solution together with 16.7 g (0.28 mol) acetic acid [1.5 m % acetic acid on combined moles of adipic acid and terephthalic acid] and 1.74 g (0.016 mol) sodium hypophosphite hydrate (to give 115 ppm P in final polymer) and 0.4 g Silwet L7605 (50%, to give 46 ppm active antifoam based upon final polymer) was added to a clean 15 L electrically heated autoclave.

In this first cycle the solution was heated and vented when the pressure reached 170 psia and continued until the temperature had reached 206° C. In the second cycle venting was ceased and the pressure allowed to rise to 265 psia over 20 minutes by when the temperature of the contents had increased to about 228° C. In the third cycle venting was continued for 34 minutes whilst keeping the system at 265 psia until the temperature of the contents had reached 260° C. In the fourth cycle the pressure was reduced to atmospheric pressure over 30 minutes and the temperature of the contents had been increased to 294° C. In the fifth cycle vacuum was applied and the pressure reduced to 350 mbar over 12 minutes and held at 350 mbar for 3 minutes, the vacuum was released with nitrogen over 1 minute and the temperature had reached 301° C. In the sixth cycle the polymer was extruded from the autoclave by a bottom extrusion valve using a maximum nitrogen pressure of 30 psia, the cast was good and of consistent viscosity with no visible signs of un-melted material. When nitrogen blow-through occurred, the pressure was released, and the extrusion valve sealed. The vessel contained residual polymer, the heel, and was ready for the next batch for processing.

A second batch (CE1B.2) was processed on the heel of the first and was processed in essentially the same manner as the first. A poor cast ensued which manifest as thick and thin lace forming due to apparent viscosity variations upon extrusion of the lace from the autoclave, the thick sections described as “lumpy”. It was not possible to form a consistent enough lace to pelletise the material.

This comparative example shows that at the 40 m % 6T level it was not possible to perform consecutive batches and achieve good casting performance when an end-capping agent was present but no other comonomer, as compared to Example 1 which had the benefit of incorporation of a small amount of another comonomer in addition to the hexamethylenediamine, adipic acid and terephthalic acid monomers and acetic acid as an end-capper.

### Example 2 (E2.1) PA66/6T/6I 63/35/2 m %

A 35 m % 6T formulation with isophthalic acid as a comonomer other than hexamethylenediamine, adipic acid and terephthalic acid. Acetic acid used as an end-capping agent.

Into a 20 L temperature controlled jacketed glass vessel fitted with overhead stirrer and condenser and maintained under an atmosphere of nitrogen was added 6333 g demineralised water, 4616 g (17.59 mol) nylon 66 salt, 1624 g (9.78 mol) terephthalic acid, 93.0 g (0.56 mol) isophthalic acid and 25.2 g (0.4 mol) acetic acid. 2425 g of a 50 w % aqueous solution of hexamethylenediamine (1213 g, 10.34 mol) was added via peristaltic pump whilst maintaining a temperature of 80° C. This produced a solution about 50 w % in strength with a mole ratio of 66/6T/6I of about 63/35/2 and contained a 1.5 m % addition of acetic acid on combined moles of adipic acid, terephthalic acid and isophthalic acid, and a 0.35 m % excess of hexamethylenediamine on combined moles of adipic acid, terephthalic acid and isophthalic acid.

This solution was added to a clean 24 L oil-heated autoclave with an agitator, together with 4.69 g sodium hypophosphite hydrate (0.44 mol, equivalent to 210 ppm P in final polymer) and 0.59 g of a 50 w % aqueous solution of Silwet L7605 antifoam agent (45 ppm active ingredient based on final polymer).

In this first cycle the solution was heated and vented when the pressure reached 170 psia and continued until the temperature had reached 198° C. In the second cycle venting was ceased and the pressure allowed to rise to 265 psia over 15 minutes by when the temperature of the contents had increased to about 217° C. In the third cycle venting was continued for 60 minutes whilst keeping the system at 265 psia until the temperature of the contents had reached 254° C. In the fourth cycle the pressure was reduced to atmospheric pressure over 35 minutes, the temperature of the contents had reached 296° C. In the fifth cycle vacuum was applied and the pressure reduced to 500 mbar over 9 minutes and held at 500 mbar for 2 minutes, the vacuum was released with nitrogen over 1 minute and the temperature had reach 298° C. In the sixth cycle the polymer was extruded from the autoclave by a bottom extrusion valve using a maximum nitrogen pressure of 25 psia. When nitrogen blow-through occurred, the pressure was released, and the extrusion valve sealed. The vessel contained residual polymer, the heel, and was ready for the next batch for processing.

A second batch (E2.2), processed on the heel of the first, was processed in essentially the same manner as the first. The polymer cast well without problems of thick/thin lace, was of good and consistent viscosity similar to the first batch and with no visible signs of un-melted material and pelletisation was possible.

A further two batches (E2.3, E2.4) were continued to be processed in this consecutive batch mode. The last batch (fourth batch or third batch as a batch-on-heel batch) cast as well as the second batch (first batch on a heel) had cast.

### Comparative Example 2A (CE2A.1) PA66/6T 65/35 m % [No “I” or “D” Comonomer]

A 35 m % 6T formulation with no comonomers other than hexamethylenediamine, adipic acid and terephthalic acid. Acetic acid used as an end-capping agent.

Into a 20 L temperature controlled jacketed glass vessel fitted with overhead stirrer and condenser and maintained under an atmosphere of nitrogen was added 6412 g demineralised water, 4604 g (17.5 mol) nylon 66 salt, 1570 g (9.45 mol) terephthalic acid, and 24.3 g (0.35 mol) acetic acid. 1981 g of a 56 w % aqueous solution of hexamethylenediamine (1109 g, 9.55 mol) was added via peristaltic pump whilst maintaining a temperature of 80° C. This produced a solution about 50 w % in strength with a mole ratio of 66/6T of about 65/35 and contained a 1.5 m % addition of acetic acid on combined moles of adipic acid and terephthalic acid, and a 0.35 m % excess of hexamethylenediamine on combined moles of adipic acid and terephthalic acid.

This solution was added to a clean 24 L oil-heated autoclave with an agitator, together with 4.53 g sodium hypophosphite hydrate (0.44 mol, equivalent to 210 ppm P in final polymer) and 0.57 g of a 50 w % aqueous solution of Silwet L7605 antifoam agent (45 ppm active ingredient based on final polymer).

In this first cycle the solution was heated and vented when the pressure reached 170 psia and continued until the temperature had reached 198° C. In the second cycle venting was ceased and the pressure allowed to rise to 265 psia over 16 minutes by when the temperature of the contents had increased to about 217° C. In the third cycle venting was continued for 70 minutes whilst keeping the system at 265 psia until the temperature of the contents had reached 253° C. In the fourth cycle the pressure was reduced to atmospheric pressure over 35 minutes, the temperature of the contents had reached 299° C. In the fifth cycle vacuum was applied and the pressure reduced to 500 mbar over 11 minutes and held at 500 mbar for 4 minutes, the vacuum was released with nitrogen over 1 minute and the temperature was 300° C. In the sixth cycle the polymer was extruded from the autoclave by a bottom extrusion valve using a maximum nitrogen pressure of 38 psia.

The polymer gave a good cast without problems of thick/thin lace, was of good and consistent viscosity with no visible signs of unmelted material. When nitrogen-blow through occurred, the pressure was released, and the extrusion valve sealed. The vessel contained residual polymer, the heel, and was ready for the next batch for processing.

A second batch (CE2A.2) was processed on the heel of the first and was processed in essentially the same manner as the first. The polymer gave a good cast but visibly was of lower melt viscosity than the first batch.

A third batch (CE2A.3) was processed on the heel of the second and was processed in essentially the same manner as the first. The polymer cast performance was similar to the second batch, having a reasonable quality but of lower melt viscosity.

A fourth batch (CE2A.4) was processed on the heel of the third and was processed in essentially the same manner as the first. Although it could be cast there were signs of bubbles and “un-melts” in the lace.

This comparative example shows that at the 35 m % 6T level when an end capping agent was present but no other comonomer, as the number of consecutive batches increases the casting performance deteriorates after only a few consecutive batches have been run, as compared to Example 2 where there was incorporation of a small amount of another comonomer in addition to the hexamethylenediamine, adipic acid and terephthalic acid monomers and acetic acid as an end capper, casting performance remained good without signs of bubbles or “un-melts”.

### Comparative Example 2B (CE2B.1) PA66/6T 65/35 m % [No “I” or “D” Comonomer]

A 35 m % 6T formulation with no comonomers other than hexamethylenediamine, adipic acid and terephthalic acid. Acetic acid used as an end-capping agent.

In a 20 L temperature controlled jacketed glass vessel fitted with overhead stirrer and condenser and maintained under an atmosphere of nitrogen a solution was made comprising 7500 g demineralised water, 2645 g adipic acid (18.10 mol), 1619 g (9.75 mol) terephthalic acid, and 3236 g hexamethylenediamine (27.85 mol) at a temperature of 80° C. This produced a solution about 50 w % in strength with a mole ratio of 66/6T of about 65/35.

This solution was added to a clean 24 L oil-heated autoclave with an agitator, together with 2.60 g sodium hypophosphite hydrate (0.025 mol, equivalent to 117 ppm P in final polymer), 25.37 g Acetic acid (0.42 mol, which was 1.5 m % on combined moles of adipic acid and terephthalic acid) and 1.8 g of a 10 w % aqueous solution of Ambersil AF 1316 antifoam agent (28 ppm active ingredient based on final polymer).

In this first cycle the solution was heated and vented when the pressure reached 170 psia and continued until the temperature had reached 198° C. In the second cycle venting was ceased and the pressure allowed to rise to 265 psia over 12 minutes by when the temperature of the contents had increased to about 221° C. In the third cycle venting was continued for 49 minutes whilst keeping the system at 265 psia until the temperature of the contents had reached 258° C. In the fourth cycle the pressure was reduced to atmospheric pressure over 35 minutes, the temperature of the contents had reached 284° C. In the fifth cycle vacuum was applied and the pressure reduced to 350 mbar over 15 minutes and held at 350-400 mbar for 5 minutes, the vacuum was released with nitrogen over 5 minute and the temperature was 293° C. In the sixth cycle the polymer was extruded from the autoclave by a bottom extrusion valve using a maximum nitrogen pressure of 35 psia.

The polymer gave a good cast without problems of thick/thin lace, was of good and consistent viscosity with no visible signs of unmelted material. When nitrogen blow-through occurred, the pressure was released, and the extrusion valve sealed. The vessel contained residual polymer, the heel, and was ready for the next batch for processing.

A second batch (CE2B.2) was processed on the heel of the first and was processed in essentially the same manner as the first. On extrusion, “high-melts” were visible and the batch was unable to be cast and pelletised.

This comparative example shows that, at the 35 m % 6T level when an end-capping agent was present but no other comonomer, even on the first batch on a heel, casting performance was very poor as compared to Example 2 where there was incorporation of a small amount of another comonomer in addition to the hexamethylenediamine, adipic acid and terephthalic acid monomers and acetic acid as an end-capper, when casting performance remained good without signs of bubbles or “un-melts”.

### Comparative Example 3A (CE3A) PA66/6T 70/30 m % [No “I” or “D” Comonomer]

A 30 m % 6T formulation with no comonomers other than hexamethylenediamine, adipic acid and terephthalic acid, without acetic acid as an end-capping agent.

Into a 20 L temperature controlled jacketed glass vessel fitted with overhead stirrer and condenser and maintained under an atmosphere of nitrogen was added 5000 g demineralised water, 3422 g (13.04 mol) nylon 66 salt, 1578 g (5.59 mol) anhydrous nylon 6T salt. This produced a solution about 50 w % in strength with a mole ratio of 66/6T of about 70/30. This solution was transferred to a clean 15 L electrically heated autoclave.

In the first cycle the solution was heated and vented when the pressure reached 170 psia and continued until the temperature had reached 209° C. In the second cycle venting was ceased and the pressure allowed to rise to 265 psia over 18 minutes by when the temperature of the contents had increased to about 229° C. In the third cycle venting was continued for 38 minutes whilst keeping the system at 265 psia until the temperature of the contents had reached 270° C. In the fourth cycle the pressure was reduced to atmospheric pressure over 30 minutes and the temperature of the contents had been increased to 285° C. In the fifth cycle vacuum was applied and the pressure reduced to 660 mbar over 10 minutes and held at 660 mbar for 6 minutes, the vacuum was released with nitrogen over 1 minute and the temperature was 285° C. In the sixth cycle the polymer was extruded from the autoclave by a bottom extrusion valve using a maximum nitrogen pressure of 30 psia, the cast was good and of consistent though visibly high melt viscosity and with no visible signs of un-melted material. When nitrogen blow-through occurred, the pressure was released, and the extrusion valve sealed. The polymer was found to have an RVS of 2.43.

### Comparative Example 3B (CE3B) PA66/6T 70/30 m % [No “I” or “D” Comonomer]

A 30 m % 6T formulation with no comonomers other than hexamethylenediamine, adipic acid and terephthalic acid, with 0.5 m % acetic acid as an end-capping agent.

The same salt procedure was used as with Comparative Example 3A but with the addition of 5.6 g (0.093 mol) acetic acid. This produced a solution about 50 w % in strength with a mole ratio of 66/6T of about 70/30 and 0.5 m % acetic acid on combined moles of terephthalic acid and adipic acid comprising the salt. This solution was transferred to a clean 15 L electrically heated autoclave.

In the first cycle the solution was heated and vented when the pressure reached 170 psia and continued until the temperature had reached 211° C. In the second cycle venting was ceased and the pressure allowed to rise to 265 psia over 20 minutes by when the temperature of the contents had increased to about 232° C. In the third cycle venting was continued for 32 minutes whilst keeping the system at 265 psia until the temperature of the contents had reached 270° C. In the fourth cycle the pressure was reduced to atmospheric pressure over 30 minutes and the temperature of the contents had been increased to 281° C. In the fifth cycle vacuum was applied and the pressure reduced to 645 mbar over 10 minutes and held at 645 mbar for 7 minutes, the vacuum was released with nitrogen over 1 minute and the temperature was 281° C. In the sixth cycle the polymer was extruded from the autoclave by a bottom extrusion valve using a maximum nitrogen pressure of 30 psia, the cast was good and of consistent melt viscosity with no thins or bubbles and with no visible signs of un-melted material. When nitrogen blow-through occurred, the pressure was released, and the extrusion valve sealed. The polymer was found to have an RVS of 2.22.

### Comparative Example 3C (CE3C) PA66/6T 70/30 m % [No “I” or “D” Comonomer]

A 30 m % 6T formulation with no comonomers other than hexamethylenediamine, adipic acid and terephthalic acid, with 1.5 m % acetic acid as an end capping agent.

Into a 20 L temperature controlled jacketed glass vessel fitted with overhead stirrer and condenser and maintained under an atmosphere of nitrogen was added 7500 g demineralised water, 5133 g (19.56 mol) nylon 66 salt, 2367 g (8.38 mol) anhydrous nylon 6T salt. This produced a solution about 50 w % in strength with a mole ratio of 66/6T of about 70/30.

This solution together with 25.0 g (0.417 mol) acetic acid, 2.61 g sodium hypophosphite hydrate (0.025 mol, equivalent to 117 ppm P in final polymer), and 1.8 g of Ambersil AF 1316 (10% antifoam as aqueous emulsion, 28 ppm active additive on final weight polymer) was added to a clean 24 L oil-heated autoclave with an agitator.

In the first cycle the solution was heated and vented when the pressure reached 170 psia and continued until the temperature had reached 199° C. In the second cycle venting was ceased and the pressure allowed to rise to 265 psia over 10 minutes by when the temperature of the contents had increased to about 217° C. In the third cycle venting was continued for 45 minutes whilst keeping the system at 265 psia until the temperature of the contents had reached 257° C. In the fourth cycle the pressure was reduced to atmospheric pressure over 36 minutes and the temperature of the contents had been increased to 292° C. In the fifth cycle vacuum was applied and the pressure reduced to 300 mbar over 15 minutes and held at 300-350 mbar for 9 minutes, the vacuum was released with nitrogen over 1 minute and the temperature was 298° C. In the sixth cycle the polymer was extruded from the autoclave by a bottom extrusion valve using a maximum nitrogen pressure of 30 psia, the cast was good and of consistent melt viscosity with no thins or bubbles and with no visible signs of un-melted material. When nitrogen blow through occurred, the pressure was released, and the extrusion valve sealed. The polymer was found to have an RVS of 2.05.

Comparative Examples 3A,4 3B and 3C were single batches on a clean autoclave (no consecutive batches) and they demonstrate the well-known effect in the art (as practiced in GB1,114,541: JPS61,159,422: EP 3,502,165) of how adding an end-capping agent limits molecular weight and consequently melt viscosity, as reflected in solution Relative Viscosity Values (RVS) values, even in the presence of a catalyst. What the art does not disclose, suggest or investigate is whether use of sufficient end-capping agent alone would enable a process for consecutive batches.

### Comparative Example 3D (CE3D) PA66/6T 70/30 m % [No “I” or “D” Comonomer]

A 30 m % 6T formulation with no comonomers other than hexamethylenediamine, adipic acid and terephthalic acid, without acetic acid as an end-capping agent.

Into a 20 L temperature controlled jacketed glass vessel fitted with overhead stirrer and condenser and maintained under an atmosphere of nitrogen was added 6871 g demineralised water, 5132 g (19.56 mol) nylon 66 salt, 1392 g (8.38 mol) terephthalic acid, and 1620 g 60% hexamethylenediamine (8.31 mol). This produced a solution about 50 w % in strength with a mole ratio of 66/6T of about 70/30.

This solution together 4.70 g sodium hypophosphite hydrate (0.044 mol, equivalent to 212 ppm P in final polymer), and 1.8 g of Ambersil AF 1316 (10% antifoam as aqueous emulsion, 28 ppm active additive on final weight polymer) was added to a clean 24 L oil-heated autoclave with an agitator.

In the first cycle the solution was heated and vented when the pressure reached 170 psia and continued until the temperature had reached 198° C. In the second cycle venting was ceased and the pressure allowed to rise to 265 psia over 15 minutes by when the temperature of the contents had increased to about 217° C. In the third cycle venting was continued for 67 minutes whilst keeping the system at 265 psia until the temperature of the contents had reached 256° C. In the fourth cycle the pressure was reduced to atmospheric pressure over 30 minutes and the temperature of the contents had been increased to 292° C. In the fifth cycle vacuum was applied and the pressure reduced to 620 mbar over 3 minutes and held at 620 mbar for 17 minutes, the vacuum was released with nitrogen over 1 minute and the temperature was 297° C. In the sixth cycle the polymer was attempted to be extruded from the autoclave by a bottom extrusion valve using a maximum nitrogen pressure of 88 psia, but the polymer was too viscous to be form a lace for casting, a small sample for analysis purposes was all that was collected. This had an RV of 3.13 and an AEG of 31.6 mpmg.

Comparative Example 3D (CE3D) demonstrates that, even at the 30 m % 6T level for a single batch produced on a clean autoclave where no end-capping agent has been used, over-polymerisation of the polymer may occur rendering the polymer uncastable. Therefore one skilled in the art would have to choose polymerisation conditions and formulations that would enable a first batch to be produced and cast before attempting to produce and casting consecutive batches on the heel of the previous batch.

### Comparative Example 3E (CE3E.1) PA66/6T 70/30 m % [No “I” or “D” Comonomer]

A 30 m % 6T formulation with no comonomers other than hexamethylenediamine, adipic acid and terephthalic acid, with 0.5 m % acetic acid used as an end-capping agent.

The same salt procedure was used as with Comparative Example 3D (CE3D) but with the addition of 8.4 g (0.14 mol) acetic acid. This produced a solution about 50 w % in strength with a mole ratio of 66/6T of about 70/30 and 0.5 m % acetic acid on combined moles of terephthalic acid and adipic acid comprising the salt.

In the first cycle the solution was heated and vented when the pressure reached 170 psia and continued until the temperature had reached 198° C. In the second cycle venting was ceased and the pressure allowed to rise to 265 psia over 13 minutes by when the temperature of the contents had increased to about 217° C. In the third cycle venting was continued for 50 minutes whilst keeping the system at 265 psia until the temperature of the contents had reached 256° C. In the fourth cycle the pressure was reduced to atmospheric pressure over 30 minutes and the temperature of the contents had been increased to 281° C. In the fifth cycle vacuum was applied and the pressure reduced to 620 mbar over 3 minutes and held at 620 mbar for 17 minutes, the vacuum was released with nitrogen over 1 minute and the temperature was 287° C. In the sixth cycle the polymer was extruded from the autoclave by a bottom extrusion valve using a maximum nitrogen pressure of 71 psia, the cast was good and consistent in terms of not too viscous nor showing evidence of unmelt, bubbles or thins. The RV of the batch was found to be 2.68.

A second batch (CE3E.2) was processed on the heel of the first and was processed in essentially the same manner as the first. It gave as good a casting performance as the first batch, but with a reduced RV of 2.16.

Comparative Example 3E demonstrates that, at the 30 m % 6T level when an end-capping agent was present but no other comonomer, at least one consecutive batch was able to be made on the heel of the previous batch with good casting performance, but other undesirable effects also occurred, in this case a drop in RV from first to second batch.

### Example 4 (E4.1) PA 66/6T/6I 69/29/2 m %

A 29 m % 6T formulation with isophthalic acid being used as a comonomer other than hexamethylenediamine, adipic acid and terephthalic acid, with 1.5 m % Acetic acid as an end-capping agent.

Into a 20 L temperature controlled jacketed glass vessel fitted with overhead stirrer and condenser and maintained under an atmosphere of nitrogen was added 7260 g demineralised water, 5059 g (19.28 mol) nylon 66 salt, 1346 g (8.10 mol) terephthalic acid and 93 g (0.56 mol) isophthalic acid. 1258 g of an 80 w % aqueous solution of hexamethylenediamine (1006 g, 8.66 mol) was added via peristaltic pump whilst maintaining a temperature of 80° C. This produced a solution about 50 w % in strength with a mole ratio of 66/6T/6I of about 69/29/2 m %.

This solution together with 25.2 g (0.42 mol) acetic acid (1.5 m % based on total terephthalic acid, isophthalic acid and adipic acid), and 1.8 g of Ambersil AF 1316 (10% solution, 28 ppm active ingredient based on final polymer) was added to a clean 24 L oil-heated autoclave with an agitator.

In the first cycle the solution was heated and vented when the pressure reached 170 psia and continued until the temperature had reached 194° C. In the second cycle venting was ceased and the pressure allowed to rise to 265 psia over 9 minutes by when the temperature of the contents had increased to about 216° C. In the third cycle venting was continued for 48 minutes whilst keeping the system at 265 psia until the temperature of the contents had reached 253° C. In the fourth cycle the pressure was reduced to atmospheric pressure over 35 minutes and the temperature of the contents had been increased to 288° C. In the fifth cycle vacuum was applied and the pressure reduced to 500 mbar over 10 minutes and held at 500 mbar for 2 minutes, the vacuum was released with nitrogen over 5 minute and the temperature was 293° C. In the sixth cycle the polymer was extruded from the autoclave by a bottom extrusion valve using a maximum nitrogen pressure of 35 psia, the cast was good and of consistent melt viscosity with no thins or bubbles and with no visible signs of un-melted material. When nitrogen blow-through occurred, the pressure was released, and the extrusion valve sealed.

A second batch (E4.2) was processed on the heel of the first and was processed in essentially the same manner as the first. The polymer gave a good cast.

A third batch (E4.3) was processed on the heel of the second and was processed in essentially the same manner as the first. The polymer gave a good cast.

A fourth batch (E4.4) was processed on the heel of the third and was processed in essentially the same manner as the first. The polymer gave a good cast.

Example 4 demonstrates that at the 29 m % 6T level when an end-capping agent was present and at least one other comonomer, the commoner did not detract from being able to use a process that allowed for consecutive batch to be made on the heel of the previous batch whilst giving good and acceptable casting performance.

### Example 5 (E5.1) PA66/6T/6I 62/32/6 m %

A 32 m % 6T formulation with isophthalic acid being used as a comonomer other than hexamethylenediamine, adipic acid and terephthalic acid, with 1.5 m % acetic acid as an end-capping agent.

Into a 20 L temperature controlled jacketed glass vessel fitted with overhead stirrer and condenser and maintained under an atmosphere of nitrogen was added 7260 g demineralised water, 4546 g (17.33 mol) nylon 66 salt, 1485 g (8.94 mol) terephthalic acid and 278 g (1.67 mol) isophthalic acid. 1542 g of an 80 w % aqueous solution of hexamethylenediamine (1234 g, 10.62 mol) was added via peristaltic pump whilst maintaining a temperature of 80° C. This produced a solution about 50 w % in strength with a mole ratio of 66/6T/6I of about 62/32/6 m %.

This solution together with 25.2 g (0.42 mol) acetic acid (1.5 m % based on total terephthalic acid, isophthalic acid and adipic acid), and 1.8 g of Ambersil AF 1316 (10% solution, 29 ppm active ingredient based on final polymer) was added to a clean 24 L oil-heated autoclave with an agitator.

In the first cycle the solution was heated and vented when the pressure reached 170 psia and continued until the temperature had reached 194° C. In the second cycle venting was ceased and the pressure allowed to rise to 265 psia over 9 minutes by when the temperature of the contents had increased to about 216° C. In the third cycle venting was continued for 52 minutes whilst keeping the system at 265 psia until the temperature of the contents had reached 253° C. In the fourth cycle the pressure was reduced to atmospheric pressure over 35 minutes and the temperature of the contents had been increased to 289° C. In the fifth cycle vacuum was applied and the pressure reduced to 500 mbar over 9 minutes and held at 500 mbar for 2 minutes, the vacuum was released with nitrogen over 1 minute and the temperature was 292° C. In the sixth cycle the polymer was extruded from the autoclave by a bottom extrusion valve using a maximum nitrogen pressure of 35 psia. As extruded the molten lace was of consistent melt viscosity with no thins or bubbles and with no visible signs of un-melted material. Cooling of the polymer lace in the water chute provided an amorphous lace for which pelletisation was optimised by slightly extending the cooling length of the water chute relative to the other inventive Examples reported herein. When nitrogen blow-through occurred, the pressure was released, and the extrusion valve sealed.

A second batch (E5.2) was processed on the heel of the first and when cast gave a crystalline lace on cooling in the water chute. The polymer gave a good cast and was easily pelletised.

A third batch (E5.3) was processed on the heel of the second and was processed in essentially the same manner as the second. The polymer gave a good cast.

A fourth batch (E5.4) was processed on the heel of the third and was processed in essentially the same manner as the second. The polymer gave a good cast.

Example 5 illustrates that at relatively higher levels of comonomer, the rate of crystallisation of the copolyamide may become supressed such that relatively more cooling may be appropriate for optimal pelletisation. Example 5 also illustrates that the heel of a previous batch can affect the crystallisation behaviour of a subsequent batch, which in this example induces nucleation and crystallisation and be beneficial for pelletisation.

### Example 6 (E6.1) PA 66/6T/6I 64/34/2 m %

A 34 m % 6T formulation with isophthalic acid being used as a comonomer other than hexamethylenediamine, adipic acid and terephthalic acid, with 1.5 m % acetic acid as an end-capping agent.

Into a 20 L temperature controlled jacketed glass vessel fitted with overhead stirrer and condenser and maintained under an atmosphere of nitrogen was added 7260 g demineralised water, 4692 g (17.88 mol) nylon 66 salt, 1578 g (9.50 mol) terephthalic acid and 93 g (0.56 mol) isophthalic acid. 1461 g of an 80 w % aqueous solution of hexamethylenediamine (1169 g, 10.06 mol) was added via peristaltic pump whilst maintaining a temperature of 80° C. This produced a solution about 50 w % in strength with a mole ratio of 66/6T/6I of about 64/34/2 m %.

This solution together with 25.2 g (0.42 mol) acetic acid (1.5 m % based on total terephthalic acid, isophthalic acid and adipic acid), and 1.8 g of Ambersil AF 1316 (10% solution, 28 ppm active ingredient based on final polymer) was added to a clean 24 L oil-heated autoclave with an agitator.

In the first cycle the solution was heated and vented when the pressure reached 170 psia and continued until the temperature had reached 194° C. In the second cycle venting was ceased and the pressure allowed to rise to 265 psia over 11 minutes by when the temperature of the contents had increased to about 216° C. In the third cycle venting was continued for 47 minutes whilst keeping the system at 265 psia until the temperature of the contents had reached 253° C. In the fourth cycle the pressure was reduced to atmospheric pressure over 36 minutes and the temperature of the contents had been increased to 286° C. In the fifth cycle vacuum was applied and the pressure reduced to 500 mbar over 9 minutes and held at 500 mbar for 2 minutes, the vacuum was released with nitrogen over 1 minute and the temperature was 292° C. In the sixth cycle the polymer was extruded from the autoclave by a bottom extrusion valve using a maximum nitrogen pressure of 35 psia. The polymer solidified to a semi-crystalline polymer in the water chute. When nitrogen blow-through occurred, the pressure was released, and the extrusion valve sealed.

A second batch (E6.2) was processed on the heel of the first and when cast gave a crystalline lace on cooling in the water chute, occasional high melts observed. The polymer gave a good cast and was easily pelletised.

A third batch (E6.3) was processed on the heel of the second and was processed in essentially the same manner as the second, occasional high melts observed. The polymer gave a good cast and was easily pelletised.

A fourth batch (E6.4) was processed on the heel of the third and was processed in essentially the same manner as the second, some high melts observed but the polymer gave a cast well and was easily pelletised.

Example 6 demonstrates that, at the 34 m % 6T level, the presence of an end-capping agent and at least one other comonomer allows for consecutive batches to be made on the heel of the previous batches which cast well without problems of thick/thin lace, and of good and consistent viscosity.

### Example 7 (E7.1) PA 66/6T/DI 63/35/2 m %

A 35 m % 6T formulation with isophthalic acid (I) and 2-methylpentamethylenediamine (D) as comonomers other than hexamethylenediamine, adipic acid and terephthalic acid. Acetic acid used as an end-capping agent. Isophthalic acid and 2-methylpentamethylenediamine were both added at the 2 m % level.

Into a 20 L temperature controlled jacketed glass vessel fitted with overhead stirrer and condenser and maintained under an atmosphere of nitrogen was added 6731 g demineralised water, 4628 g (17.64 mol) nylon 66 salt, 1628 g (9.80 mol) terephthalic acid, 93.0 g (0.56 mol) isophthalic acid, 65.0 g Dytek A (2-methylpentamethylenediamine, 0.56 mol) and 25.2 g (0.4 mol) acetic acid. 1912 g of a 60 w % aqueous solution of hexamethylenediamine (1147 g, 9.87 mol) was added via peristaltic pump whilst maintaining a temperature of 80° C. This produced a solution about 50 w % in strength with a mole ratio of 66/6T/DI of about 63/35/2 and contained a 1.5 m % addition of acetic acid on combined moles of adipic acid, terephthalic acid and isophthalic acid, and a 0.26 m % excess of hexamethylenediamine on combined moles of adipic acid, terephthalic acid and isophthalic acid.

This solution was added to a clean 24 L oil-heated autoclave with an agitator, together with 4.70 g sodium hypophosphite hydrate (0.44 mol, equivalent to 210 ppm P in final polymer) and 0.59 g of a 50 w % aqueous solution of Silwet L7605 antifoam agent (45 ppm active ingredient based on final polymer).

In this first cycle the solution was heated and vented when the pressure reached 170 psia and continued until the temperature had reached 198° C. In the second cycle venting was ceased and the pressure allowed to rise to 265 psia over 15 minutes by when the temperature of the contents had increased to about 217° C. In the third cycle venting was continued for 70 minutes whilst keeping the system at 265 psia until the temperature of the contents had reached 255° C. In the fourth cycle the pressure was reduced to atmospheric pressure over 35 minutes, the temperature of the contents had reached 297° C. In the fifth cycle vacuum was applied and the pressure reduced to 550 mbar over 3 minutes and held at 550 mbar for 7 minutes, the vacuum was released with nitrogen and the temperature had reach 297° C. In the sixth cycle the polymer was extruded from the autoclave by a bottom extrusion valve using a maximum nitrogen pressure of 42 psia. The polymer cast was good in terms of no noticeable unmelts nor excessive bubbles in the lace. When nitrogen blow-through occurred, the pressure was released, and the extrusion valve sealed. The vessel contained residual polymer, the heel, and was ready for the next batch for processing.

A second batch (E7.2), processed on the heel of the first, was processed in essentially the same manner as the first. The polymer cast well, though a small amount of thin lace occurred (within acceptable limits), was of good and consistent viscosity with no visible signs of un-melted material and pelletisation was possible.

A further two batches (E7.3, E7.4) were continued to be processed in this consecutive batch mode. The last batch (fourth batch or third batch as a batch-on-heel batch) cast as well as the first batch.

Example 7 demonstrates that, at the 34 m % 6T level, the presence of an end-capping agent and two other comonomers allows for consecutive batches to be made on the heel of the previous batches which cast well without excessive or unacceptable problems of thick/thin lace, and generally of good and consistent viscosity.

### Example 8 (E8.1) PA 66/6T/DI 58/40/2 m %

A 40 m % 6T formulation with isophthalic acid (I) and 2-methylpentamethylenediamine (D) as comonomers other than hexamethylenediamine, adipic acid and terephthalic acid. Acetic acid used as an end-capping agent. Isophthalic acid and 2-methylpentamethylenediamine were both added at the 2 m % level.

Into a 20 L temperature controlled jacketed glass vessel fitted with overhead stirrer and condenser and maintained under an atmosphere of nitrogen was added 6651 g demineralised water, 4261 g (16.24 mol) nylon 66 salt, 1861 g (11.2 mol) terephthalic acid, 93.0 g (0.56 mol) isophthalic acid, 65.0 g Dytek A (2-methylpentamethylenediamine, 0.56 mol) and 25.2 g (0.4 mol) acetic acid. 2186 g of a 60 w % aqueous solution of hexamethylenediamine (1312 g, 11.29 mol) was added via peristaltic pump whilst maintaining a temperature of 80° C. This produced a solution about 50 w % in strength with a mole ratio of 66/6T/DI of about 58/40/2 and contained a 1.5 m % addition of acetic acid on combined moles of adipic acid, terephthalic acid and isophthalic acid, and a 0.30 m % excess of hexamethylenediamine on combined moles of adipic acid, terephthalic acid and isophthalic acid.

This solution was added to a clean 24 L oil-heated autoclave with an agitator, together with 4.70 g sodium hypophosphite hydrate (0.44 mol, equivalent to 210 ppm P in final polymer) and 0.59 g of a 50 w % aqueous solution of Silwet L7605 antifoam agent (45 ppm active ingredient based on final polymer).

In this first cycle the solution was heated and vented when the pressure reached 170 psia and continued until the temperature had reached 198° C. In the second cycle venting was ceased and the pressure allowed to rise to 265 psia over 17 minutes by when the temperature of the contents had increased to about 217° C. In the third cycle venting was continued for 76 minutes whilst keeping the system at 265 psia until the temperature of the contents had reached 265° C. In the fourth cycle the pressure was reduced to atmospheric pressure over 35 minutes, the temperature of the contents had reached 306° C. In the fifth cycle vacuum was applied and the pressure reduced to 550 mbar over 10 minutes, the vacuum was released with nitrogen and the temperature was 305° C. In the sixth cycle the polymer was extruded from the autoclave by a bottom extrusion valve using a maximum nitrogen pressure of 44 psia. The polymer cast was good in terms of no noticeable unmelts, though some occurrences of thin lace were observed. When nitrogen blow-through occurred, the pressure was released, and the extrusion valve sealed. The vessel contained residual polymer, the heel, and was ready for the next batch for processing.

A second batch (E8.2), processed on the heel of the first, was processed in essentially the same manner as the first. The polymer cast well good in terms of no noticeable unmelts, though some occurrences of thin lace were observed.

Example 8 demonstrates that, at the 40 m % 6T level, the presence of an end-capping agent and two other comonomers allows for consecutive batches to be made on the heel of the previous batches, although albeit with some occurrences of thin lace, but within acceptable limits.

### Example 9 (E9.1) PA 66/6T/DI 56/40/4 m %

A 40 m % 6T formulation with isophthalic acid (I) and 2-methylpentamethylenediamine (D) as comonomers other than hexamethylenediamine, adipic acid and terephthalic acid. Acetic acid used as an end-capping agent. Isophthalic acid and 2-methylpentamethylenediamine were both added at the 4 m % level.

Into a 20 L temperature controlled jacketed glass vessel fitted with overhead stirrer and condenser and maintained under an atmosphere of nitrogen was added 6587 g demineralised water, 4114 g (15.68 mol) nylon 66 salt, 1861 g (11.2 mol) terephthalic acid, 186.0 g (1.12 mol) isophthalic acid, 130.0 g Dytek A (2-methylpentamethylenediamine, 1.12 mol) and 25.2 g (0.4 mol) acetic acid. 2186 g of a 60 w % aqueous solution of hexamethylenediamine (1312 g. 11.29 mol) was added via peristaltic pump whilst maintaining a temperature of 80° C. This produced a solution about 50 w % in strength with a mole ratio of 66/6T/DI of about 56/40/4 and contained a 1.5 m % addition of acetic acid on combined moles of adipic acid, terephthalic acid and isophthalic acid, and a 0.30 m % excess of hexamethylenediamine on combined moles of adipic acid, terephthalic acid and isophthalic acid.

This solution was added to a clean 24 L oil-heated autoclave with an agitator, together with 4.70 g sodium hypophosphite hydrate (0.44 mol, equivalent to 210 ppm P in final polymer) and 0.59 g of a 50 w % aqueous solution of Silwet L7605 antifoam agent (45 ppm active ingredient based on final polymer).

In this first cycle the solution was heated and vented when the pressure reached 170 psia and continued until the temperature had reached 198° C. In the second cycle venting was ceased and the pressure allowed to rise to 265 psia over 14 minutes by when the temperature of the contents had increased to about 217° C. In the third cycle venting was continued for 70 minutes whilst keeping the system at 265 psia until the temperature of the contents had reached 265° C. In the fourth cycle the pressure was reduced to atmospheric pressure over 34 minutes, the temperature of the contents had reached 302° C. In the fifth cycle vacuum was applied and the pressure reduced to 670 mbar over 3 minutes, and held at 670 mbar for 10 minutes, the vacuum was released with nitrogen and the temperature was 301° C. In the sixth cycle the polymer was extruded from the autoclave by a bottom extrusion valve using a maximum nitrogen pressure of 50 psia. The polymer cast was good in terms of no noticeable unmelts, and very few thin lace events were observed. When nitrogen blow-through occurred, the pressure was released, and the extrusion valve sealed. The vessel contained residual polymer, the heel, and was ready for the next batch for processing.

A second batch (E9.2), processed on the heel of the first, was processed in essentially the same manner as the first. The polymer cast well in terms of no noticeable unmelts and few thin lace events and few bubbles.

Example 9 demonstrates that, at the 40 m % 6T level, the presence of an end-capping agent and two other comonomers allows for consecutive batches to be made on the heel of the previous batches, and that by increasing the level of the two other comonomers, as compared to Example 8, that casting performance was very acceptable.

In the Examples and Comparative Examples above the temperature at the end of the high-pressure cycle was always well below the melting point of the final polymer, when the melting point was determined by DSC analysis either on the polymer produced in the Example or Comparative Example or from data produced by a polymer of the same formulation.

### Example 10 (E10.1) PA 66/6T/6I 63/35/2 m %

A 35 m % 6T formulation with isophthalic acid being used as a comonomer other than hexamethylenediamine, adipic acid and terephthalic acid, with 1.5 m % acetic acid as an end-capping agent.

Into a 20 L temperature controlled jacketed glass vessel fitted with overhead stirrer and condenser and maintained under an atmosphere of nitrogen was added 6742 g demineralised water, 4616 g (17.59 mol) nylon 66 salt, 1624 g (9.78 mol) terephthalic acid and 93 g (0.56 mol) isophthalic acid. 2009 g of a 60 w % aqueous solution of hexamethylenediamine (1205 g, 10.37 mol) was added via peristaltic pump whilst maintaining a temperature of 80° C.

This produced a solution about 50 w % in strength with a mole ratio of 66/6T/6I of about 63/35/2 m %. 5 g of 60 w % aqueous solution of hexamethylenediamine was added. A small sample of the salt mix was diluted to 9.5 w % and the pH was measured as 7.60.

The salt solution together with 25.2 g (0.42 mol) acetic acid (1.5 m % based on total terephthalic acid, isophthalic acid and adipic acid), 41 g 60 w % hexamethylenediamine (0.21 mol) to balance the acetic acid addition, 4.69 g Sodium Hypophosphite (0.04 mol, 210 ppm phosphorus on final polymer) added as a catalyst, a further 80 g of 60 w % aqueous solution of hexamethylenediamine (0.41 mol) added to raise the amine end group content in the final polymer, and 0.59 g of Silwet L7605 antifoam (50% solution, 45 ppm active ingredient based on final polymer) was added to a clean 24 L oil-heated autoclave with an agitator.

In the first cycle the solution was heated and vented when the pressure reached 170 psia and continued until the temperature had reached 198° C. In the second cycle venting was ceased and the pressure allowed to rise to 265 psia over 14 minutes by when the temperature of the contents had increased to about 219° C. In the third cycle venting was continued for 42 minutes whilst keeping the system at 265 psia until the temperature of the contents had reached 255° C. In the fourth cycle the pressure was reduced to atmospheric pressure over 31 minutes and the temperature of the contents had been increased to 287° C. In the fifth cycle vacuum was applied and the pressure reduced to 410 mbar over 2 minutes and held at 480 mbar for 10 minutes, the vacuum was released with nitrogen over 5 minutes and the temperature was 287° C. In the sixth cycle the polymer was extruded from the autoclave by a bottom extrusion valve using a maximum nitrogen pressure of 45 psia, the cast was good and of consistent melt viscosity with no visible signs of un-melted material. When nitrogen blow-through occurred, the pressure was released, and the extrusion valve sealed. The polymer had an RVS of 2.40 and an AEG of 80.7 mpmg.

A second batch (E10.2) was processed on the heel of the first and was processed in essentially the same manner as the first.

A third batch (E10.3) was processed on the heel of the second and was processed in essentially the same manner as the first. The polymer gave a good cast.

A fourth batch (E10.4) was processed on the heel of the third and was processed in essentially the same manner as the first. The polymer gave a good cast.

Example 10 demonstrates that, at the 35 m % 6T level, the presence of an end-capping agent and one other comonomer (isophthalic acid in this example), and an excess of hexamethylenediamine, allowed for consecutive batches to be made on the heel of the previous batches whilst giving good and acceptable casting performance whilst also giving product with a high amine end group level.

### Example 11 (E11.1) PA 66/6T/DI 63/35/2 m %

A 35 m % 6T formulation with isophthalic acid and 2-methylpentamethylenediamine being used as comonomers other than hexamethylenediamine, adipic acid and terephthalic acid, with 1.5 m % acetic acid as an end-capping agent.

Into a 20 L temperature controlled jacketed glass vessel fitted with overhead stirrer and condenser and maintained under an atmosphere of nitrogen was added 6333 g demineralised water, 4616 g (17.59 mol) nylon 66 salt, 1624 g (9.78 mol) terephthalic acid, 93 g (0.56 mol) isophthalic acid, and 65 g 2-methylpentamethylenediamine (0.56 mol, Dytek AR). 1895 g of a 60 w % aqueous solution of hexamethylenediamine (1137 g, 9.79 mol) was added via peristaltic pump whilst maintaining a temperature of 80° C.

This produced a solution about 50 w % in strength with a mole ratio of 66/6T/DI of about 63/35/2 m %. A small sample of the salt mix was diluted to 9.5 w % and the pH was measured as 7.60.

The salt solution together with 25.2 g (0.42 mol) acetic acid (1.5 m % based on total terephthalic acid, isophthalic acid and adipic acid), 41 g 60 w % hexamethylenediamine (0.21 mol) to balance the acetic acid addition, 4.69 g Sodium Hypophosphite (0.04 mol, 210 ppm phosphorus on final polymer) added as a catalyst, a further 80 g of 60 w % aqueous solution of hexamethylenediamine (0.41 mol) added to raise the amine end group content in the final polymer, and 0.59 g of Silwet L7605 antifoam (50% solution, 45 ppm active ingredient based on final polymer) was added to a clean 24 L oil-heated autoclave with an agitator.

In the first cycle the solution was heated and vented when the pressure reached 170 psia and continued until the temperature had reached 198° C. In the second cycle venting was ceased and the pressure allowed to rise to 265 psia over 15 minutes by when the temperature of the contents had increased to about 217° C. In the third cycle venting was continued for 49 minutes whilst keeping the system at 265 psia until the temperature of the contents had reached 255° C. In the fourth cycle the pressure was reduced to atmospheric pressure over 33 minutes and the temperature of the contents had been increased to 291° C. In the fifth cycle vacuum was applied and the pressure reduced to 480 mbar over 12 minutes, the vacuum was released with nitrogen over 5 minutes and the temperature was 292° C. In the sixth cycle the polymer was extruded from the autoclave by a bottom extrusion valve using a maximum nitrogen pressure of 45 psia, the cast was good and of consistent melt viscosity with no visible signs of un-melted material. When nitrogen blow-through occurred, the pressure was released, and the extrusion valve sealed. The polymer had an RVS of 2.34 and an AEG of 86.6 mpmg.

A second batch (E11.2) was processed on the heel of the first and was processed in essentially the same manner as the first. The polymer had an RVS of 2.18 and an AEG of 85.5 mpmg.

A third batch (E11.3) was processed on the heel of the second and was processed in essentially the same manner as the first. The polymer gave a good cast. The polymer had an RVS of 2.50 and an AEG of 87.4. mpmg.

Example 11 demonstrates that, at the 35 m % 6T level, the presence of an end-capping agent and two other comonomers (isophthalic acid and 2-methylpentamethylenediamine), and an excess of hexamethylenediamine, allowed for consecutive batches to be made on the heel of the previous batches whilst giving good and acceptable casting performance whilst also giving product with a high amine end group level.

DSC, RVS and AEG Results for the above Examples are given in Tables 1A, 1B and 1C below.

TABLE 1A
66/6T [no “I” or “D” comonomer]

| | | | | | DSC Data - | | | | |
|---|---|---|---|---|---|---|---|---|---|
| | | | | | 2 cycles | | | | |
| | | | | | [Delta H in | | | | AEG in |
| | | | Cumulative | | J/g] | | | | moles per |
| | | | number | | 1^{st} Heat/1^{st} | | Crystal- | | million |
| | 66/6T/6I | | of | Cast | Cool | Melting | lization | Relative | grams |
| Example | mole | AcOH | batches | Perfor- | 2^{nd} Heat/2^{nd} | Temp | Temp | Viscosity, | polymer |
| ID. | ratio | (m %) | on heel | mance | Cool | (° C.) | (° C.) | RVS* | (mpmg) |
| CE1A.1 | 60/40/— | 1.5 | 0 | Good | 40.7/−35.5 | 294.8 | 255.6 | 2.50 | 37.0 |
| | | | | | 33.4/−36.7 | | | | |
| CE1A.2 | 60/40/— | 1.5 | 1 | Poor | 37.3/−36.8 | 294.8 | 257.5 | 2.37 | nd |
| | | | | | 28.7/−37.1 | | | | |
| CE1B.1 | 60/40/— | 1.5 | 0 | Good | 46.5/−43.1 | 303.0 | 251.1 | 2.11 | 6.1 |
| | | | | | 38.5/−40.1 | | | | |
| CE1B.2 | 60/40/— | 1.5 | 1 | Poor | 54.5/−43.6 | 303.3 | 250.0 | 2.22 | 9.4 |
| | | | | | 52.3/−42.3 | | | | |
| CE2A.1 | 65/35/— | 1.5 | 0 | Good | 46.0/−39.3 | 289.5 | 246.9 | 2.23 | 26.9 |
| | | | | | 33.1/−39.5 | | | | |
| CE2A.2 | 65/35/— | 1.5 | 1 | Good | 56.7/−44.8 | 287.3 | 235.8 | 2.03 | 21.2 |
| | | | | | 30.5/−43.1 | | | | |
| CE2A.3 | 65/35/— | 1.5 | 2 | Good | 52.9/−47.3 | 287.3 | 235.1 | 1.68 | 20.5 |
| | | | | | 38.2/−46.1 | | | | |
| CE2A.4 | 65/35/— | 1.5 | 3 | Poor [with | 53.5/−42.5 | 289.9 | 246.2 | 2.06 | 19.2 |
| | | | | bubbles and | 55.2/−36.6 | | | | |
| | | | | high melts] | | | | | |
| CE2B.1 | 65/35/— | 1.5 | 0 | Good | nd | nd | Nd | 2.26 | 16.1 |
| CE2B.2 | 65/35/— | 1.5 | 1 | Poor | nd | nd | Nd | 2.14 | 14.4 |
| CE3A | 70/30/— | 0 | 0 | Good | nd | nd | Nd | 2.43 | 44.2 |
| CE3B | 70/30/— | 0.5 | 0 | Good | nd | nd | Nd | 2.22 | 32.7 |
| CE3C | 70/30/— | 1.5 | 0 | Good | nd | nd | Nd | 2.05 | 17.3 |
| CE3D | 70/30/— | 0 | 0 | Unable | nd | nd | Nd | 3.13 | 31.6 |
| | | | | to cast, | | | | | |
| | | | | too high | | | | | |
| | | | | viscosity | | | | | |
| CE3E.1 | 70/30/— | 0.5 | 0 | Good | 43.2/−35.5 | 281.0 | 230.8 | 2.68 | 28.6 |
| | | | | | 27.6/−34.7 | | | | |
| CE3E.2 | 70/30/— | 0.5 | 1 | Good | 46.6/−40.3 | 275.9 | 225.6 | 2.16 | 21.0 |
| | | | | | 33.4/−38.9 | | | | |

nd—not determined
RVS*—Relative Viscosity measured in a 1.0 wt./vol. % solution of the polymer sample in 96% sulfuric acid [ASTM D789 Method]

TABLE 1B
66/6T with 6I component in the 2-6 m % range

| | | | | | DSC Data - | | | | |
|---|---|---|---|---|---|---|---|---|---|
| | | | | | 2 cycles | | | | |
| | | | | | [Delta H in | | | | AEG in |
| | | | Cumulative | | J/g] | | | | moles per |
| | | | number | | 1^{st} Heat/1^{st} | | Crystal- | | million |
| | 66/6T/6I | | of | Cast | Cool | Melting | lization | Relative | grams |
| Example | mole | AcOH | batches | Perfor- | 2^{nd} Heat/2^{nd} | Temp | Temp | Viscosity, | polymer |
| ID. | ratio | (m %) | on heel | mance | Cool | (° C.) | (° C.) | RVS* | (mpmg) |
| E1.1 | 58/40/2 | 1.5 | 0 | Good | nd | nd | nd | nd | nd |
| E1.2 | 58/40/2 | 1.5 | 1 | Good | 34.0/−34.5 | 296.1 | 249.8 | 2.46 | 54.9 |
| | | | | | 25.9/−33.2 | | | | |
| E1.3 | 58/40/2 | 1.5 | 2 | Good | 39.8/−40.2 | 291.1 | 247.0 | 2.18 | nd |
| | | | | | 27.1/−38.7 | | | | |
| E1.4 | 58/40/2 | 1.5 | 3 | Good | 38.4/−38.9 | 296.5 | 251.3 | 2.22 | 35.7 |
| | | | | | 29.0/−39.4 | | | | |
| E1.5 | 58/40/2 | 1.5 | 4 | Good | 41.4/−40.7 | 291.5 | 247.7 | 2.20 | nd |
| | | | | | 26.7/−39.7 | | | | |
| E1.6 | 58/40/2 | 1.5 | 5 | Good | 35.5/−40.3 | 294.8 | 258.3 | 2.23 | nd |
| | | | | | 27.2/−41.8 | | | | |
| E2.1 | 63/35/2 | 1.5 | 0 | Good | 49.8/−42.9 | 287.2 | 237.0 | 2.06 | 145.4 |
| | | | | | 34.1/−42.3 | | | | |
| E2.2 | 63/35/2 | 1.5 | 1 | Good | 48.5/−44.4 | 286.5 | 236.0 | 2.10 | 150.7 |
| | | | | | 29.4/−42.7 | | | | |
| E2.3 | 63/35/2 | 1.5 | 2 | Good | 43.4/−37.0 | 293.1 | 240.1 | 2.12 | 146.6 |
| | | | | | 31.0/−35.7 | | | | |
| E2.4 | 63/35/2 | 1.5 | 3 | Good | nd | nd | Nd | 2.01 | 149.7 |
| E4.1 | 69/29/2 | 1.5 | 0 | Good | 56.7/−46.4 | 281.8 | 227.0 | 2.03 | 24.2 |
| | | | | | 36.7/−42.6 | | | | |
| E4.2 | 69/29/2 | 1.5 | 1 | Good | nd | nd | Nd | 1.96 | 25.4 |
| E4.3 | 69/29/2 | 1.5 | 2 | Good | nd | nd | Nd | 2.02 | 24.7 |
| E4.4 | 69/29/2 | 1.5 | 3 | Good | 57.4/−49.2 | 278.8 | 226.4 | 2.03 | 22.5 |
| | | | | | 38.3/−49.2 | | | | |
| E5.1 | 62/32/6 | 1.5 | 0 | Cooled | 62.8/−44.4 | 281.0 | 224.6 | 2.01 | 23.3 |
| | | | | lace | 34.1/−43.3 | | | | |
| | | | | amorphous | | | | | |
| E5.2 | 62/32/6 | 1.5 | 1 | Good; | nd | nd | Nd | 2.05 | 24.6 |
| | | | | cooled | | | | | |
| | | | | lace semi- | | | | | |
| | | | | crystalline | | | | | |
| E5.3 | 62/32/6 | 1.5 | 2 | Good; | 47.8/−43.6 | 280.7 | 223.6 | 2.02 | 24.8 |
| | | | | cooled | 30.0/−40.0 | | | | |
| | | | | lace semi- | | | | | |
| | | | | crystalline | | | | | |
| E5.4 | 62/32/6 | 1.5 | 3 | Good; | 59.9/−42.0 | 283.5 | 224.0 | 2.08 | 23.8 |
| | | | | cooled | 30.6/−39.6 | | | | |
| | | | | lace semi- | | | | | |
| | | | | crystalline | | | | | |
| E6.1 | 64/34/2 | 1.5 | 0 | — | 60.7/−47.0 | 286.6 | 231.7 | 2.05 | 23.4 |
| | | | | | 34.4/−47.0 | | | | |
| E6.2 | 64/34/2 | 1.5 | 1 | Good | 51.9/−44.7 | 287.6 | 232.4 | 2.02 | 22.7 |
| | | | | | 32.2/−41.5 | | | | |
| E6.3 | 64/34/2 | 1.5 | 2 | Good, | 60.4/−52.3 | 289.3 | 234.1 | 2.05 | 21.5 |
| | | | | occasional | 36.8/−52.3 | | | | |
| | | | | high melts | | | | | |
| E6.4 | 64/34/2 | 1.5 | 3 | Good, | 52.7/−46.2 | 285.7 | 233.8 | 2.13 | 22.7 |
| | | | | occasional | 33.1/−45.1 | | | | |
| | | | | high melts | | | | | |
| E10.1 | 63/35/2 | 1.5 | 0 | Good | nd | nd | Nd | 2.40 | 80.7 |
| E10.2 | 63/35/2 | 1.5 | 1 | Good | nd | nd | Nd | 2.29 | 82.9 |
| E10.3 | 63/35/2 | 1.5 | 2 | Good | nd | nd | Nd | 2.35 | 87.7 |
| E10.4 | 63/35/2 | 1.5 | 3 | Good | nd | nd | Nd | 2.26 | 89.4 |

n/d—not determined
RVS*—Relative Viscosity measured in a 1.0 wt./vol. % solution of the polymer sample in 96% sulfuric acid [ASTM D789 Method]

TABLE 1C
66/6T with DI component in the 2-4 m % range

| | | | | | DSC Data - | | | | |
|---|---|---|---|---|---|---|---|---|---|
| | | | | | 2 cycles | | | | |
| | | | | | [Delta H in | | | | AEG in |
| | | | Cumulative | | J/g] | | | | moles per |
| | | | number | | 1^{st} Heat/1^{st} | | Crystal- | | million |
| | 66/6T/DI | | of | Cast | Cool | Melting | lization | Relative | grams |
| Example | mole | AcOH | batches | Perfor- | 2^{nd} Heat/2^{nd} | Temp | Temp | Viscosity, | polymer |
| ID. | ratio | (m %) | on heel | mance | Cool | (° C.) | (° C.) | RVS* | (mpmg) |
| E7.1 | 63/35/2 | 1.5 | 0 | Good | 42.6/−35.3 | 281.3 | 231.8 | 2.38 | 28.0 |
| | | | | | 27.3/−35.2 | | | | |
| E7.2 | 63/35/2 | 1.5 | 1 | Good, | 41.8/−36.5 | 278.8 | 228.0 | 2.12 | 29.8 |
| | | | | occasional | 31.2/−35.4 | | | | |
| | | | | thins | | | | | |
| E7.3 | 63/35/2 | 1.5 | 2 | Good | 42.9/−39.7 | 279.8 | 228.3 | 2.28 | 26.2 |
| | | | | | 27.3/−38.2 | | | | |
| E7.4 | 63/35/2 | 1.5 | 3 | Good | 40.6/−37.1 | 279.4 | 228.6 | 2.24 | 28.8 |
| | | | | | 24.9/−36.3 | | | | |
| E8.1 | 58/40/2 | 1.5 | 0 | Good, | 40.3/−39.8 | 286.7 | 234.2 | 2.12 | 35.4 |
| | | | | some thins | 23.0/−38.3 | | | | |
| E8.2 | 58/40/2 | 1.5 | 1 | Good, | 36.4/−36.7 | 286.3 | 238.1 | 2.39 | 30.2 |
| | | | | some thins | 21.9/−35.5 | | | | |
| E9.1 | 56/40/4 | 1.5 | 0 | Good | 38.2/−37.2 | 278.3 | 227.5 | 2.38 | 30.5 |
| | | | | | 22.7/−36.4 | | | | |
| E9.2 | 56/40/4 | 1.5 | 1 | Good | 34.9/−36.7 | 280.7 | 237.2 | 2.57 | 24.1 |
| | | | | | 18.4/−33.7 | | | | |
| E11.1 | 63/35/2 | 1.5 | 0 | Good | nd | nd | Nd | 2.34 | 86.6 |
| E11.2 | 63/35/2 | 1.5 | 1 | Good | nd | nd | Nd | 2.18 | 85.5 |
| E11.3 | 63/35/2 | 1.5 | 2 | Good | nd | nd | Nd | 2.50 | 87.4 |

nd—not determined
RVS*—Relative Viscosity measured in a 1.0 wt./vol. % solution of the polymer sample in 96% sulfuric acid [ASTM D789 Method]

1-32. (canceled)

33. A polymerization process for producing consecutive batches of a copolyamide comprising terephthalic acid, adipic acid and hexamethylenediamine, said process comprising:
(a) introducing into a batch vessel said copolyamide monomeric units of terephthalic acid, adipic acid and hexamethylenediamine to provide a reaction mixture;
(b) introducing into said batch vessel an end-capping agent and at least one comonomer(s) other than terephthalic acid, adipic acid and hexamethylenediamine;
(c) subjecting the batch vessel contents to conditions sufficient to form said copolyamide; and
(d) recovering said copolyamide product from the vessel;
wherein the batch vessel is not cleaned out between the consecutive batches.

34. The process according to claim 33 wherein the process comprises the production of a first batch of said copolyamide and the recovery thereof from said batch vessel in accordance with said steps (a) to (d), and further comprises the production of a second batch of said copolyamide and optionally at least one subsequent batch of said copolyamide, wherein the production steps of each of said second and optional subsequent batch(es) correspond to said steps (a) to (d).

35. The process according to claim 33 wherein upon completion of step (d) in each production batch there remains in the batch vessel residual copolyamide product, defined as the heel, wherein said second and optional subsequent batch(es) are processed on the heel of the preceding batch, and wherein the amount of said heel represents no more than 10 weight % of the maximum theoretical yield from the batch.

36. The process according to claim 33 wherein said reaction mixture further comprises water.

37. The process according to claim 33 wherein said terephthalic acid, adipic acid, hexamethylenediamine, end-capping agent and other comonomer(s) are contacted in a mixing vessel and then introduced into said batch vessel.

38. The process according to claim 33 wherein said adipic acid and a portion of the total amount of said hexamethylenediamine needed to make the copolyamide are in the form of a nylon salt.

39. The process according to claim 33 wherein the total amount of diamine in the reaction mixture is in excess relative to the combined molar amount of adipic acid, terephthalic acid and any carboxylic acid-containing compounds of said other comonomer(s).

40. The process according to claim 33 wherein the batch vessel is subjected to a maximum pressure of about 320 psia, wherein the maximum temperature of the vessel contents during the highest pressure stage is less than the melting point of the final copolyamide product.

41. The process according to claim 33 wherein the temperature of the final contents of the batch vessel is limited to a maximum of 320° C.

42. The process according to claim 33 wherein the copolyamide product comprises from 0.5 to 2.5 m % end-capping agent.

43. The process according to claim 33 wherein the copolyamide product comprises from 0.5 to 6.0 m % of each of said one or more comonomer(s) other than terephthalic acid, adipic acid, or hexamethylenediamine.

44. The process according to claim 33 wherein the copolyamide product comprises a plurality of said comonomers other than terephthalic acid, adipic acid, or hexamethylenediamine, and the total amount of said comonomers is no more than 12 m %.

45. The process according to claim 33 wherein the copolyamide product exhibits a hexamethylene terephthalamide mole fraction, which is defined as the 6T component, of from 25 to 45 m %.

46. The process according to claim 33 wherein the copolyamide product exhibits a hexamethylene adipamide mole fraction, which is defined as the 66 component, of from 50 to 70 m %.

47. The process according to claim 33 wherein the copolyamide product exhibits a hexamethylene terephthalamide mole fraction (6T component) of from 35 to 45 m % and the amount of at least one of said one or more comonomer(s) other than terephthalic acid, adipic acid, or hexamethylenediamine present in the copolyamide is in the range of 2.5 to 6.0 m %.

48. The process according to claim 33 wherein the copolyamide product exhibits a hexamethylene terephthalamide mole fraction (6T component) of less than 35 m % and the total amount of hexamethylenediamine in the reaction mixture is in excess relative to the combined molar amount of adipic acid, terephthalic acid and any carboxylic acid-containing compounds of said other comonomer(s) wherein said excess is from 0.1 to less than 3.0 m % relative to the combined molar amount of adipic acid, terephthalic acid and any carboxylic acid-containing compounds of said other comonomer(s).

49. The process according to claim 33 wherein the end-capping agent is selected from: mono-functional organic carboxylic acids; mono-functional organic amines; 1,4-dicarboxylic acids which react with an amine end to form an end-capping 5-membered imide ring structure; anhydrides which react with an amine end to form an end-capping 5-membered imide ring structure; and anhydrides which react with an amine end to form an end-capping 6-membered imide ring structure.

50. The process according to claim 33 wherein said at least one comonomer(s) other than terephthalic acid, adipic acid and hexamethylenediamine are selected from isophthalic acid (I), 2-methylpentamethylenediamine (D), and combinations thereof.

51. A copolyamide made according to the process of claim 33.

52. A copolyamide containing monomeric units derived from terephthalic acid, adipic acid, hexamethylenediamine, at least one comonomer other than terephthalic acid, adipic acid and hexamethylenediamine, and an end-capping agent, wherein the Relative Viscosity measured in a 1.0 wt./vol. % solution of the copolyamide sample in 96% sulfuric acid according to ASTM D789 Method is in the range of 1.8 to 2.8, and wherein the amine end group content is in the range of 15 to 160 mpmg.
